(19) United States
(12) Patent Application Publication
(10) Pub. No.: US 2022/0211219 A1
(43) Pub. Date: Jul. 7, 2022

(54) Food Transportation Systems

(71) Applicant: Phase Change Energy Solutions, Inc., Asheboro, NC (US)

(72) Inventors: Byron C. Owens, Asheboro, NC (US); Glinda Goodson, Asheboro, NC (US); Emmanuel Mena, Asheboro, NC (US); John A. Gerig, Greensboro, NC (US)

(73) Assignee: Phase Change Energy Solutions, Inc., Asheboro, NC (US)

(21) Appl. No.: 17/607,538

(22) PCT Filed: Apr. 30, 2020
(86) PCT No.: PCT/US2020/030628

§ 371 Date: Oct. 29, 2021

Related U.S. Application Data
(60) Provisional application No. 62/840,942, filed on Apr. 30, 2019.

(51) Int. Cl. A47J 47/14

(52) U.S. Cl. CPC A47J 47/145; A45C 7/0077

(57) ABSTRACT

In one aspect, food transport systems are described herein. In some embodiments, such a system comprises an interior compartment defined by a floor, one or more side walls, and optionally a lid. The lid has open and closed configurations. The lid, or a bottom surface thereof, is in facing opposition to the floor when the lid is in the closed configuration. The side walls comprise fold lines or seams substantially parallel to the floor. Further, the side walls have reduced thickness or rigidity or self-supporting ability at the fold lines. The interior compartment has an extended configuration and a folded configuration. When the interior compartment is in the extended configuration, the side walls are substantially orthogonal to the floor. When the interior compartment is in the folded configuration, the side walls are folded or collapsed onto themselves along the fold lines, in a direction orthogonal to the floor.

### CROSS REFERENCE TO RELATED APPLICATIONS

This application claims priority under 35 U.S.C. § 119 to U.S. Provisional Patent Application No. 62/840,942, filed Apr. 30, 2019, the entirety of which is hereby incorporated by reference herein.

### FIELD

The present disclosure relates to food transportation systems and methods of using such systems, including for temperature management of prepared food.

### BACKGROUND

The transport of food, especially prepared food, from one location to another is an area of increasing concern. A number of food transport systems or containers have been developed for food transport and delivery, including for so called “last mile” delivery of prepared foods. However, some previous food transport systems suffer from one or more disadvantages, especially for the transportation of prepared foods that have been previously cooked, assembled, or otherwise prepared by a food preparer, and that are ready for consumption. So called “fresh-prepared” foods can be particularly challenging to transport in an acceptable manner, since these foods are not commercially produced (such as canned foods or other “off the shelf” foods are commercially produced) but are instead prepared upon receipt of an order from an end user (or consumer) or only shortly before (e.g., within 60 minutes, 30 minutes, 15 minutes, 10 minutes, or 5 minutes) such an order is expected to be received. Disadvantages of some previous systems include, but are not necessarily limited to, minimal or no ability to maintain or control the temperature of food during transport, bulkiness when not in use, minimal or no ability to maintain or control food security, and minimal or no ability to track the location of the food transport system. Improved food transport systems are therefore desired.

### SUMMARY

In one aspect, food transportation systems or containers or bags are described herein. Such systems or containers or bags, in some cases, can provide one or more advantages compared to some existing systems, containers, or bags. In some embodiments, for example, a system, container, or bag described herein can provide improved temperature control or maintenance of products such as food placed within the system, container, or bag. A system or container or bag described herein can also, in some cases, collapse or fold when not in use, so as to decrease the amount of space occupied by the system or container or bag in a restaurant, kitchen, or other location in which space may be limited. Additionally, a system or container or bag described herein may include multiple openings or lids that can opened or closed with one hand, that do not attract or retain food particles or other debris, and/or that provide selective access to different compartments or interior volume regions of the system or container or bag. Other possible advantages are further described hereinbelow.

In some preferred embodiments, a food transport or transportation system, container, or bag described herein comprises an interior compartment, cavity, or receiving space defined by a floor or bottom or bottom surface, one or more side walls, and optionally a lid. The lid has a closed configuration and an open configuration. Moreover, in some cases, the lid, or a bottom surface of the lid, is in facing opposition to the floor, when the lid is in the closed configuration. Such food transportation systems, containers, or bags can have a number of additional components and/or features that provide one or more advantages. For example, in some implantations of a system, container, or bag described herein, the side walls comprise one or more fold lines or seams substantially parallel to the floor of the interior compartment. Further, in some such cases, the side walls have reduced thickness or rigidity or self-supporting ability at the fold lines or seams. In addition, in some embodiments, the interior compartment has an extended configuration and a folded configuration and, when the interior compartment is in the extended configuration, the side walls are substantially orthogonal to the floor. In contrast, when the interior compartment is in the folded configuration, the side walls are folded or collapsed onto themselves along the fold lines and in a direction orthogonal to the floor, as described further hereinbelow.

Moreover, in some embodiments, a system, container, or bag described herein further comprises at least one opening or passageway disposed in the lid (when or if present), or in the side walls of the system, container, or bag. The opening provides access to the interior compartment from an exterior environment of the food transportation system, container, or bag. Such an opening can have other features further described hereinbelow.

In still other implementations, a flap or apron is disposed within the interior compartment of a system, container, or bag described herein, wherein the flap or apron is positioned adjacent to the opening or passageway. Such a flap or apron can have other features and provide other benefits described hereinbelow. In addition, in some cases, a system (or container or bag) described herein further comprises a foldable shelf or other shelf that divides the interior compartment of the system (or container or bag) into a top portion and bottom portion. A first food or portion of food can be placed in the top portion, above or on the shelf, and a second food or portion of food can be placed in the bottom portion, beneath the shelf. Moreover, in some embodiments, the shelf (or other component of the system) comprises a phase change material and/or a heating element. Such a heating element can be used for actively heating the interior volume and/or for inducing a phase transition in the phase change material (when present), thereby “charging” the phase change material and storing thermal energy as latent heat, which latent heat can subsequently be used for “passively” heating or maintaining a desired temperature within the interior volume. In still other instances, a plurality of rigid posts is disposed within the interior compartment and positioned substantially orthogonal to the floor, including in such a manner as to support a shelf or divider, as described further hereinbelow.

A system, container, or bag described herein may also comprise a data collection device, such as a GPS tracking device, a temperature monitoring device, a humidity monitoring device, or a combination of two or more of the foregoing. The foregoing and additional features of various components of food transportation systems are described further in the detailed description which follows.

In another aspect, methods of storing and/or transporting food (or other products) are described herein. In some preferred embodiments, the food is prepared food. In some cases, such a method comprises placing the food (or other product) in the interior volume or compartment of a system, container, or bag described herein (such as a system, container, or bag described hereinabove). The method further comprises transporting the food (or other product) from a first location to a second location, and removing the food (or other product) from the interior volume of the system at the second location. Moreover, in some embodiments, the method does not comprise attaching the system (or container or bag) to an electrical power supply while transporting the food (or other product) from the first location to the second location. Further, in some implementations, the system (or container or bag) comprises a phase change material (PCM) disposed in the interior volume of the system, and the method further comprises heating or cooling the PCM above or below a phase transition temperature of the PCM prior to placing the food in the interior volume of the container.

These and other implementations are described in more detail in the detailed description which follows.

### BRIEF DESCRIPTION OF THE DRAWINGS

FIG. 1 illustrates a front perspective view of a food transportation system according to one embodiment described herein.

FIG. 2 illustrates a perspective view of a front and side of the food transportation system of FIG. 1.

FIG. 3 illustrates a front and side perspective view of the food transportation system of FIG. 1.

FIG. 4 illustrates a rear perspective view of the food transportation system of FIG. 1.

FIGS. 5A and 5B illustrate rear perspective views of an optional transport device for a food transportation system described herein.

FIG. 6 illustrates a perspective view of a food transportation system described herein while in use.

FIGS. 7A, 7B, and 7C illustrate a sequence of converting a food transportation system according to one embodiment described herein from an extended configuration to a collapsed configuration.

FIG. 8 illustrates a rear perspective view of a food transportation system according to one embodiment described herein with a cover in an open position.

FIG. 9 illustrates a front perspective view of one embodiment of a food transportation system described herein where a lid is in an open position.

FIG. 10 illustrates a front perspective view of one embodiment of a food transportation system described herein where a lid is in an open position and a shelf is positioned in an interior cavity.

FIG. 11 illustrates a front perspective view of one embodiment of a food transportation system described herein where a cover on a side wall is in an open position.

FIG. 12 illustrates another front perspective view of the food transportation system in FIG. 11.

FIG. 13 illustrates a top perspective view of one embodiment of a food transportation system described herein where a cover on a lid is in an open position.

FIG. 14 illustrates a front perspective view of one embodiment of a food transportation system described herein where a cover on a lid is in an open position and a cover on a side wall is in an open position.

FIG. 15 illustrates an enlarged view of one embodiment of a food transportation system described herein where a cover is in an open position and an opening is exposed.

FIG. 16A and FIG. 16B each illustrates a partial view of a flap in an interior compartment of one embodiment of a food transportation system described herein.

FIG. 16C illustrates a perspective view of a flap in an interior compartment of one embodiment of a food transportation system described herein.

FIG. 17A illustrates a front perspective view of a food transportation system in a collapsed configuration according to one embodiment described herein.

FIG. 17B illustrates a side perspective view of a first side of the food transportation system of FIG. 17A.

FIG. 17C illustrates a rear perspective view of the food transportation system of FIG. 17A.

FIG. 17D illustrates a side perspective view of a second side (opposite the first side) of the food transportation system of FIG. 17A.

FIG. 18 illustrates an enlarged perspective view of a tethering mechanism of a food transportation system according to one embodiment described herein.

FIGS. 19A and 19B illustrate perspective views of an exemplary shelf in an open (or upright) configuration and a closed (or collapsed) configuration, respectively.

FIG. 20 illustrates a perspective view of a rigid post in an interior compartment of a food transportation system according to one embodiment described herein.

FIG. 21 illustrates an enlarged perspective view of a rear side wall having a power cord for a food transportation system described herein.

FIG. 22 illustrates an enlarged perspective view of a rear side wall of a food transportation system according to one embodiment described herein having a thermal status indicator.

FIG. 23 illustrates a plan view of a top of a heater/shelf according to one embodiment described herein.

FIG. 24 illustrates a side view of the heater/shelf of FIG. 23.

FIG. 25 illustrates another side view of the heater/shelf of FIG. 23, where the view of FIG. 25 is rotated 90 degrees from the view of FIG. 24 (rotation occurring about an axis that lies within the plane of the sheet.

FIG. 26 illustrates a perspective view of a top of the heater/shelf of FIG. 23.

FIG. 27 illustrates a perspective view of a bottom of the heater/shelf of FIG. 23.

FIG. 28 illustrates a cross-sectional view of a stack of layers disposed within a heater/shelf according to one embodiment described herein.

FIG. 29 illustrates a plan view of the stack of layers shown in FIG. 28.

FIG. 30 illustrates an exploded view of the layers in the heater/shelf shown in FIG. 28.

FIG. 31 illustrates a perspective view of an exemplary data collection device concealed within a food transportation system according to one embodiment described herein.

### DETAILED DESCRIPTION

Implementations and embodiments described herein can be understood more readily by reference to the following detailed description, examples, and drawings. Elements, apparatus, and methods described herein, however, are not limited to the specific implementations presented in the detailed description, examples, and drawings. It should be recognized that these implementations are merely illustrative of the principles of the present disclosure. Numerous modifications and adaptations will be readily apparent to those of skill in the art without departing from the spirit and scope of the disclosure.

In addition, all ranges disclosed herein are to be understood to encompass any and all subranges subsumed therein. For example, a stated range of “1.0 to 10.0” should be considered to include any and all subranges beginning with a minimum of 1.0 or more and ending with a maximum value of 10.0 or less, e.g., 1.0 to 5.3, or 4.7 to 10.0, or 3.6 to 7.9. Similarly, as will be clearly understood, a stated range of “1 to 10” should be considered to include any and all subranges beginning with a minimum of 1 or more and ending with a maximum value of 10 or less, e.g., 1 to 6, or 7 to 10, or 3.6 to 7.9.

All ranges disclosed herein are also to be considered to include the end points of the range, unless expressly stated otherwise. For example, a range of “between 5 and 10,” “from 5 to 10,” or “5-10” should generally be considered to include the end points of 5 and 10.

In the following description, exemplary food transportation systems are described. However, it is to be understood that the described transportation systems are not limited to only transporting food; systems described herein can also be used to transport any product or object that requires heating or cooling or temperature control, such as medicines, chemical reagents, transplant organs, blood and tissue samples, and the like. Thus, more generally product transportation systems are described herein. Additionally, throughout the following description, references to “food” or the transportation or delivery of “food” can generally be replaced with references to products or the delivery of a “product” or “products,” wherein the products may be food products (including prepared food products or raw food products), pharmaceuticals, vaccines, biological tissues or blood, chemical reagents, or other products.

For purposes of brevity and conciseness, transportations systems described herein will be referred to as “system” or “systems”.

### I. Food Transportation Systems

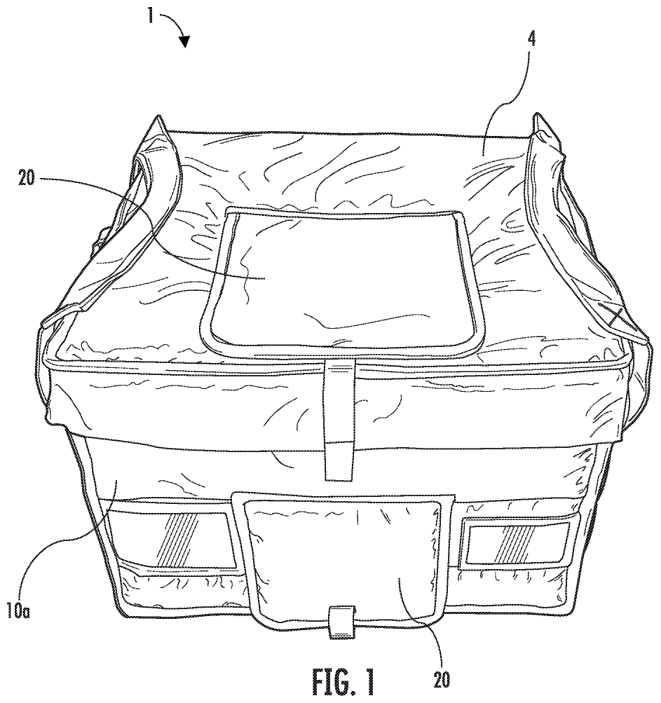

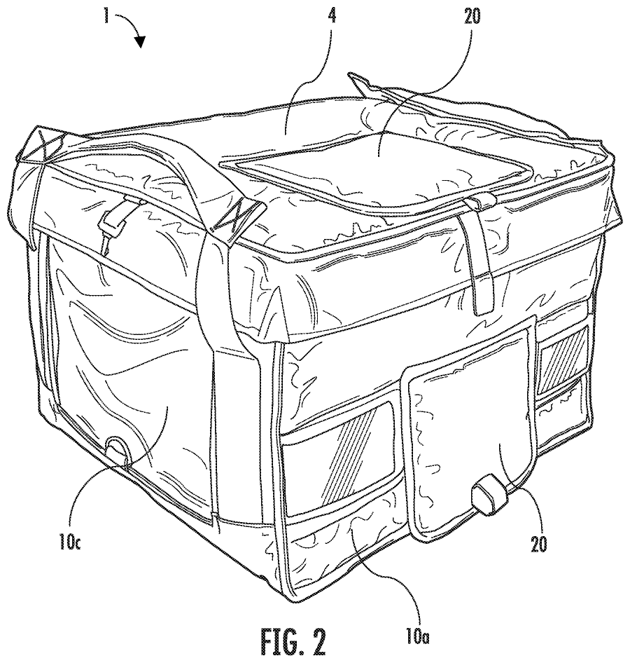

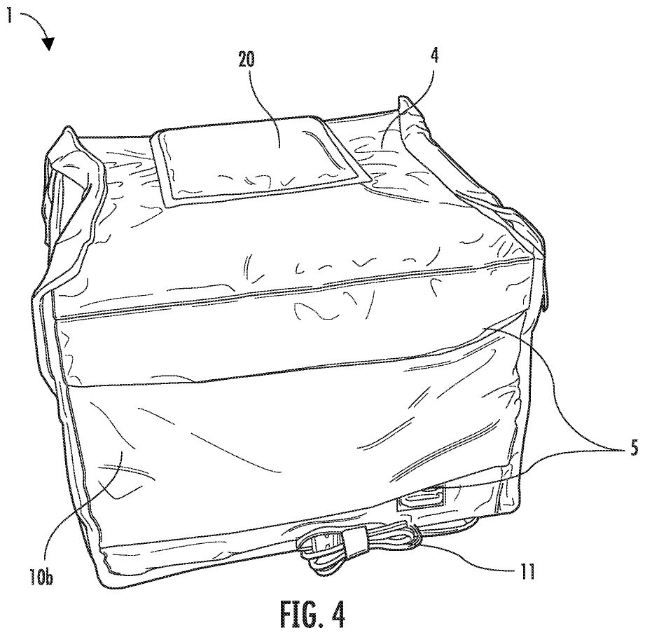

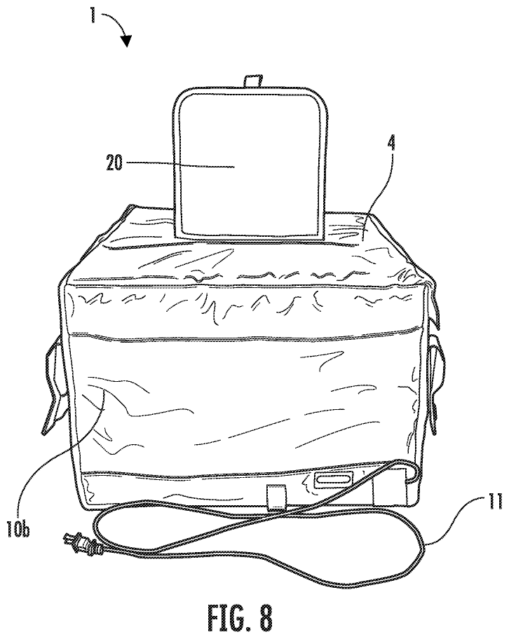

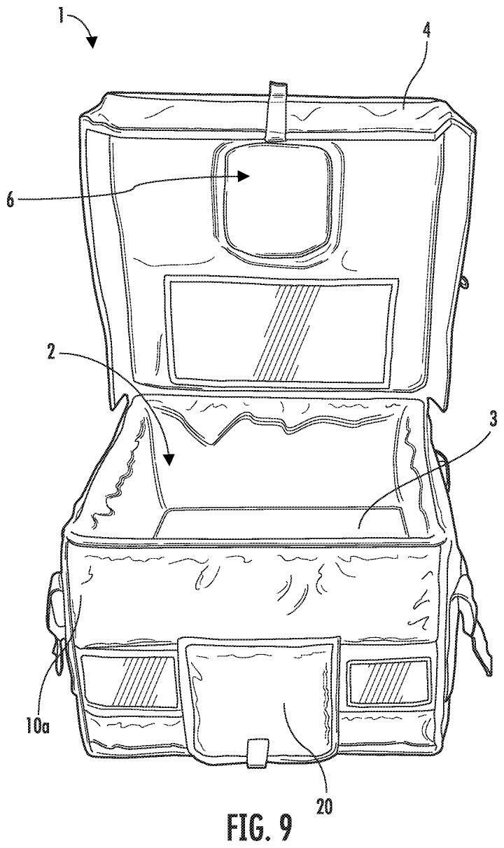

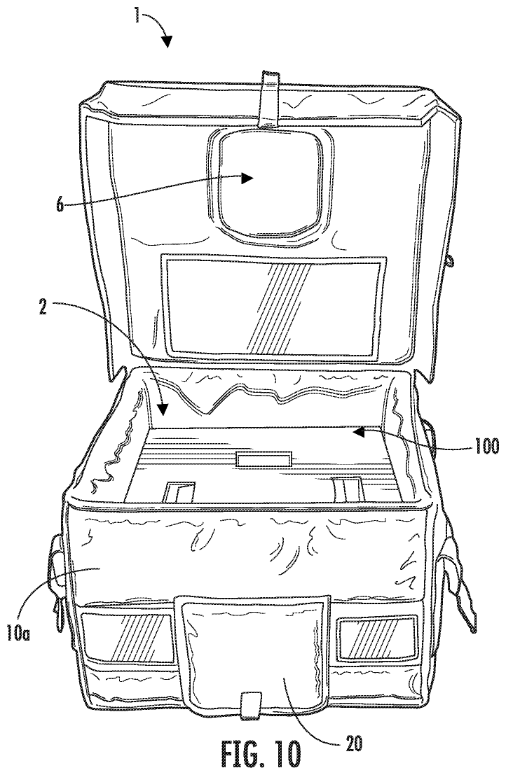

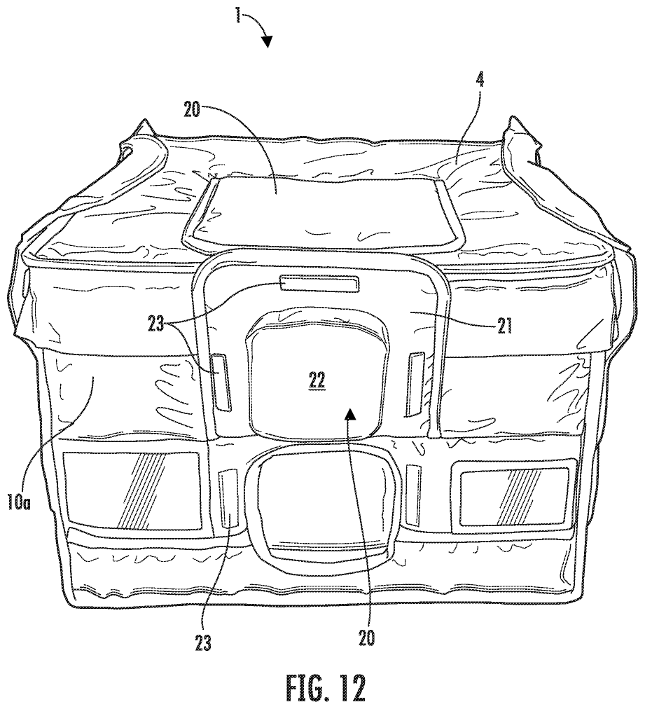

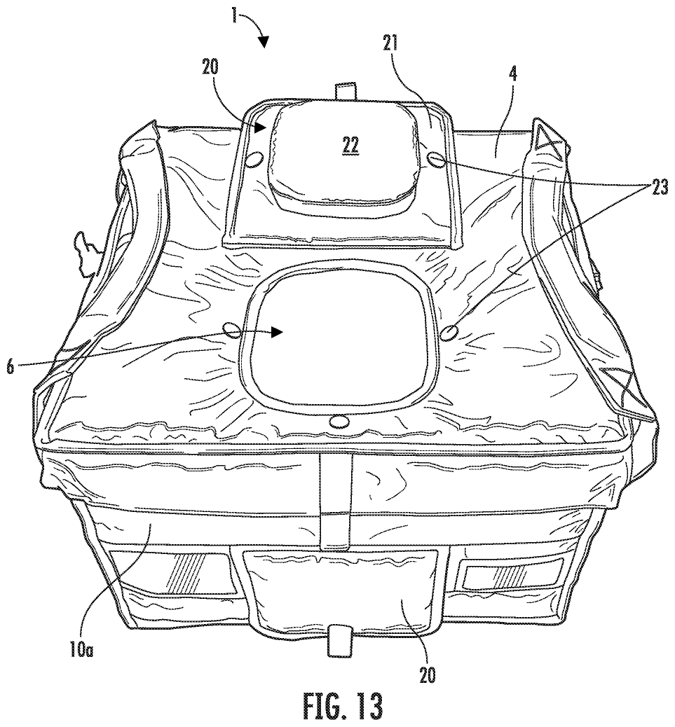

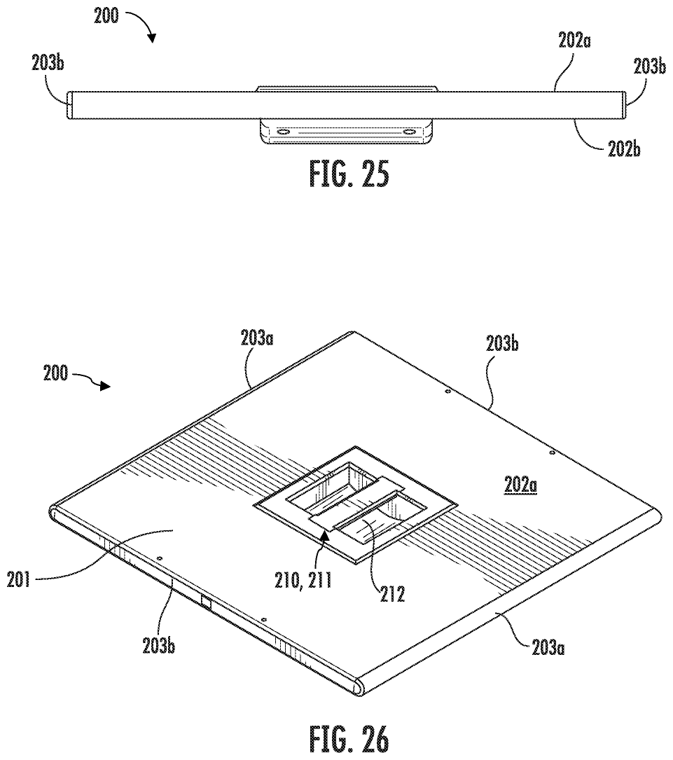

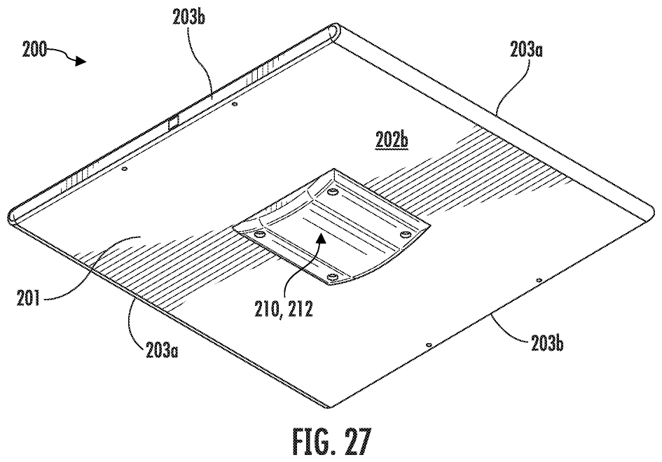

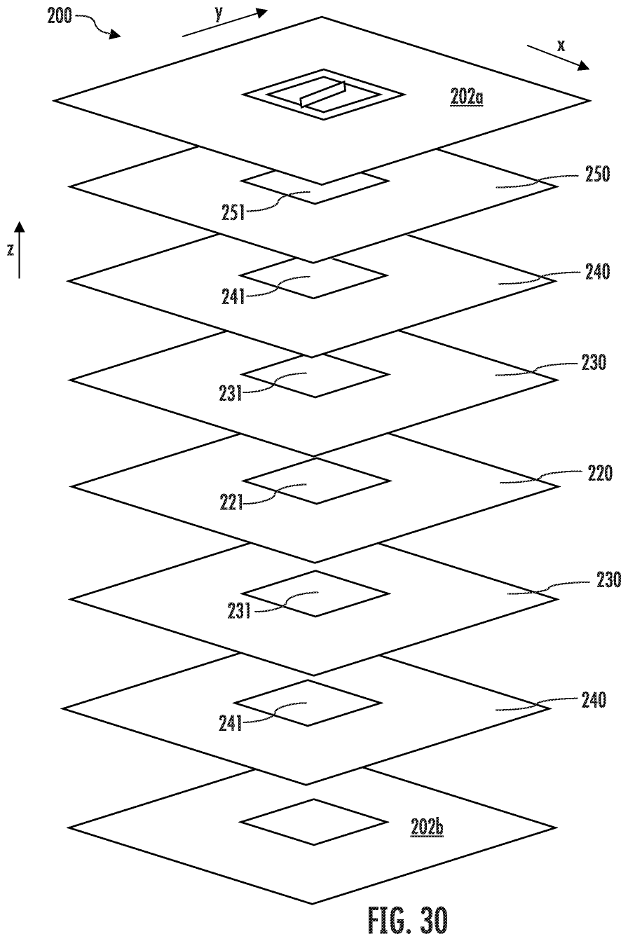

In one aspect, food transportation systems are described herein, with reference to FIGS. 1-31. In some embodiments, food transportation systems described herein can be in the form of a container or bag. As generally shown in at least FIGS. 1-13, a food transportation system 1 described herein comprises an interior compartment, cavity, or receiving space 2 defined by a floor 3 (which may also be referred to as bottom or bottom surface), and one or more side walls 10a-10d. In some cases, the food transportation system comprises a lid 4 having a closed configuration and an open configuration. In the closed configuration, a bottom surface of lid 4 is in facing opposition to floor 3, as depicted for example, in at least FIGS. 1-6. In the fully open configuration, the bottom surface of lid 4 is positioned orthogonal to floor 3, as shown for instance, in FIGS. 8 and 9.

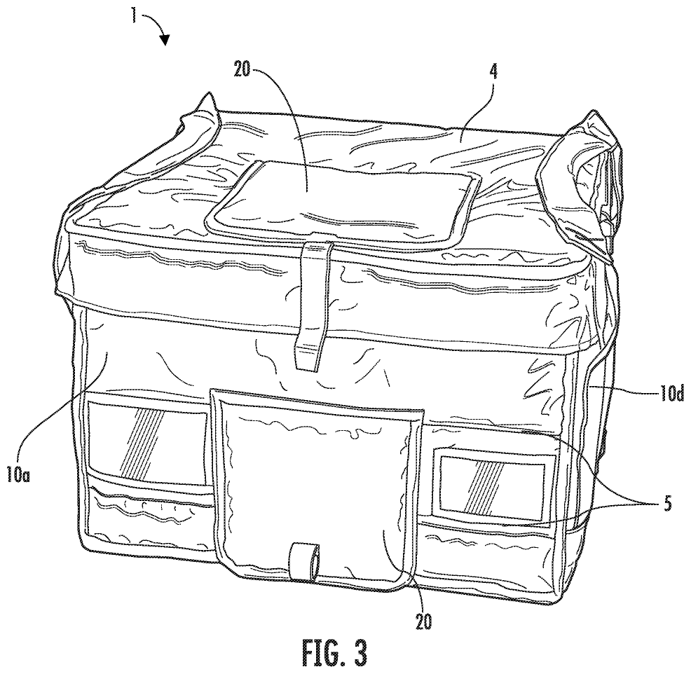

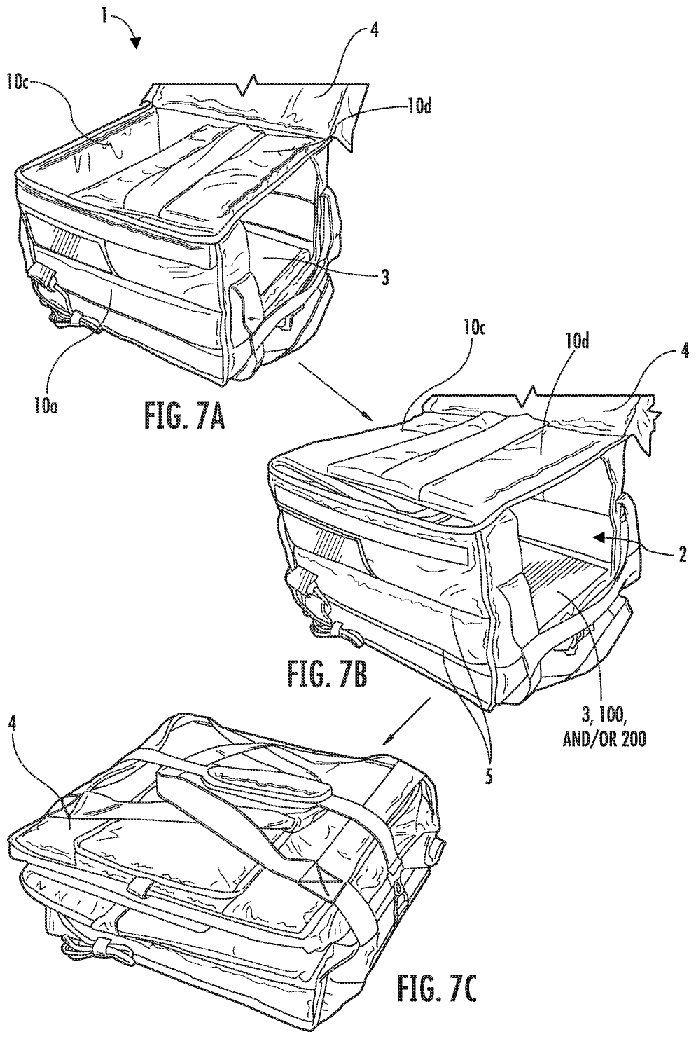

Food transportation systems described herein can include a number of additional components and/or features that provide one or more advantages, as described further herein. For example, in some preferred embodiments, the side walls of the system comprise one or more fold lines or seams extending substantially parallel to the floor of the interior compartment, such as fold lines or seams 5 shown in FIGS. 3 and 7B. In addition, in some cases, the side walls have reduced thickness (or rigidity or self-supporting ability) at the fold lines, measured in the dimension extending from the exterior environment to the interior compartment of the food transportation system (from the side). The reduced thickness at the fold lines can in some instances reduce the rigidity or self-supporting ability of the side walls, permitting the system to be reversibly collapsible along the fold lines, such as is illustrated in FIGS. 7A-7C. Further, in such instances, the interior compartment can have an extended configuration and a folded or collapsed configuration. When the interior compartment is in the extended configuration, the side walls are substantially orthogonal to the floor. However, when the interior compartment is in the folded or collapsed configuration, the side walls are folded or collapsed onto themselves along the fold lines and in a direction orthogonal to the floor. As further illustrated herein, the fold lines can allow the food transport system to be collapsed in the vertical or z-dimension. For purposes herein, the vertical or z-dimension is an axis extending from the top or lid of the system to the bottom or floor of the system. FIGS. 7A-7C show a sequence of converting a system from the extended configuration to a folded or collapsed configuration (shown in FIG. 7C).

Side walls described herein can be formed from any material not inconsistent with the objectives of this disclosure. In some embodiments, the side walls are formed from a fabric. For example, in some cases, the side walls are formed from a polyester, polyolefin, or polyamide (such as nylon) fabric. The fabric can be a woven or non-woven fabric.

The side walls of a system described herein can also be formed from a combination of differing materials. For example, in some cases, the side walls comprise or are formed from an exterior fabric layer, an interior fabric or plastic layer, and, optionally, an intermediate foam layer. In some such embodiments, the exterior fabric layer is the layer closest to or facing the exterior environment of the system, and comprises or is formed from a polyester fabric. The interior fabric or plastic layer is the layer closest to or facing the interior compartment or receiving space, and comprises or is formed from a nylon. The intermediate foam layer can be disposed in between the interior and exterior layers as an intermediate layer, and can comprise thermally insulating foam such as a polyethylene or polyurethane foam. An intermediate structural layer can also be provided for structural support of the side walls and/or of weight placed on the top of the system or container, such as may occur when a plurality of systems described herein are stacked on top of one another. For instance, in some embodiments, a cardboard or corrugated material such as a corrugated plastic is disposed within one or more of the side walls as an intermediate structural layer, such as between the exterior and interior layers.

Systems described herein can have any three-dimensional shape not inconsistent with the objectives of this disclosure. In some preferred embodiments, a system described herein has a “box-shaped” or rectangular prism-shaped interior volume, defined in part by four side walls, each forming a 90 degree angle with two other side walls, such as is shown. In some such instances, two of the side walls in facing opposition to one another (that is, opposite side walls, as opposed to immediately adjacent side walls) include or are formed from a material having sufficient rigidity and strength to not only maintain the system in an extended configuration, but also support up to 150 pounds, up to 115 pounds, up to 100 pounds, up to 90 pounds, up to 80 pounds, or up to 70 pounds placed on top of the system (with the weight resting on the rigid side walls) for up to 7 days, without deformation or failure of the side walls. In some cases, the rigid side walls can support 50-150 pounds, 50-115 pounds, 70-150 pounds, 70-115 pounds, 70-100 pounds, 80-150 pounds, 80-115 pounds, 80-100 pounds, 90-150 pounds, 90-115 pounds, or 100-150 pounds for 48-168 hours or for 84-168 hours, including without substantial deformation or buckling of the side walls. Such rigidity and strength can be measured in any manner not inconstant with the objectives of the present disclosure. In some cases, for instance, the support strength is measured by placing the recited weight on the top of the rigid side walls when deployed in a system described herein and timing how long the weight is supported by the rigid side walls without buckling. The rigidity and strength of rigid side walls can also be determined by measuring the bending stiffness or flexural rigidity of the side walls independently in accordance with standard TAPPI T836. In some preferred embodiments, the bending stiffness of the rigid side walls of a system described herein is at least 5 times, at least 10 times, at least 20 times, at least 50 times, or at least 100 times the bending stiffness of non-rigid side walls of the system. In some cases, the bending stiffness of the rigid side walls of a system described herein is 5-500, 5-100, 5-50, 5-20, 10-500, 10-100, 10-50, 10-20, 20-500, 20-100, 20-50, 50-500, or 50-100 times the bending stiffness of non-rigid side walls of the system. Rigid walls of a system described herein, in some cases, comprise or are formed from one or more corrugated plastic (e.g. polyethylene) sheets disposed between two fabric layers, where the corrugated plastic sheets have a thickness of up to 1 cm or up to 0.5 cm.

In addition, in some embodiments, one or more of the side walls of systems described herein are selectively movable side walls. In particular, in some cases, one or more side walls are configured to rotate or flip upward (toward the lid of the system, and away from the floor of the system) along the vertical direction, thereby reducing or eliminating structural support (in the vertical direction) present on those sides, particularly in instances in which the moveable side walls are rigid side walls. The sides of the interior volume can also in this manner be exposed to the exterior environment of the system. In some preferred embodiments, two out of four side walls are rotatable or moveable as described above, as well as being rigid side walls that provide structural support to the system and/or to a load placed on top of the system (including as described above). For example, the two side walls can be hingedly rotatable or moveable along a top rim portion of the system.

The two moveable side walls can preferably be opposite to one another, with the interior fabric or plastic layers being opposing surfaces forming the interior volume, as illustrated in the drawings. Additionally, in some such embodiments, the moveable side walls are attached to the remainder of the structure that forms or defines the interior volume only at the top of the side walls, where “top” refers to an upward or vertical direction, relative to the bottom or “floor” of the system. That is, the moveable side walls can be configured as flaps or struts that can be raised or lowered to “open” or “close” the sides of the interior volume. It is further to be noted that, in some embodiments, the moveable walls are not unattached to the rest of the structure that forms or defines the interior volume. That is, the side walls in such cases are not completely removable, though they are moveable or rotatable. Consequently, side walls having such a structure can permit a system described herein to be collapsible, including in combination with fold lines or seams described herein. Such a collapsing or folding process is further described herein with reference to the drawings.

In some cases, side walls described herein comprise or further comprise a foam disposed on an interior of the side walls. For example, a foam can be disposed on the interior layer closest to or facing the interior compartment or receiving space (and thus closest to or facing the product, such as food, disposed in the compartment). The foam can comprise a polyethylene or polyurethane foam in some instances.

As shown in at least FIGS. 1-14, an exemplary food transportation system 1 comprises an interior volume 2 defined by four orthogonal side walls 10a-10d. A first side wall 10a and second side wall 10b of the four orthogonal side walls are opposite to one another and formed from a relatively non-rigid material. A third side wall 10c and a fourth side wall 10d of the four orthogonal side walls are also opposite to one another, and are formed from a relatively rigid material. The third and fourth side walls 10c,10d are attached to the first and second side walls 10a,10b only at the top of the side walls. The third and fourth side walls 10c,10d having or formed from the relatively rigid material are configured to flip upwardly and downwardly to decrease or increase, respectively, the overall rigidity of the interior volume. For instance, as shown in the sequence in FIGS. 7A-7C, third and fourth side walls 10c,10d flip upwardly and inwardly into interior compartment 2, and first and second side walls 10a, 10b collapse, bringing lid 4 towards floor 3.

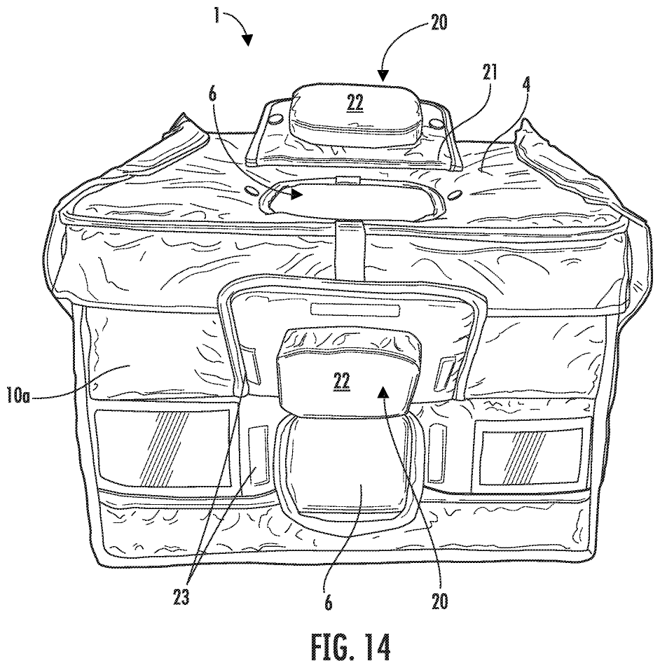

In some embodiments, a system described herein can have at least one opening, port, or passageway disposed in at least one of the side walls or in the lid when a lid is present. The opening provides access to the interior compartment from an exterior environment of the food transportation system without the need to open the lid. FIGS. 9-14 show an exemplary opening 6 formed in lid 4. The system is not limited to only one opening, and in some instances can have 2, 3, or more openings, such as an opening in at least one side wall and a lid, two openings in two different side walls, two openings in the same sidewall, and the like. However, in some preferred embodiments, there is one opening in the lid and one opening in one side wall. FIGS. 9-14 show an exemplary openings 6 in first sidewall 10a and in lid 4. In systems having a shelf (described in more detail in Section II herein) positioned in the interior volume and dividing the interior volume into two separated receiving spaces, the system can have a first opening in the side wall allowing access to one of the two separated receiving spaces and a second opening in the side wall or lid allowing access to the other of the two separated receiving spaces as shown in FIG. 14 for example.

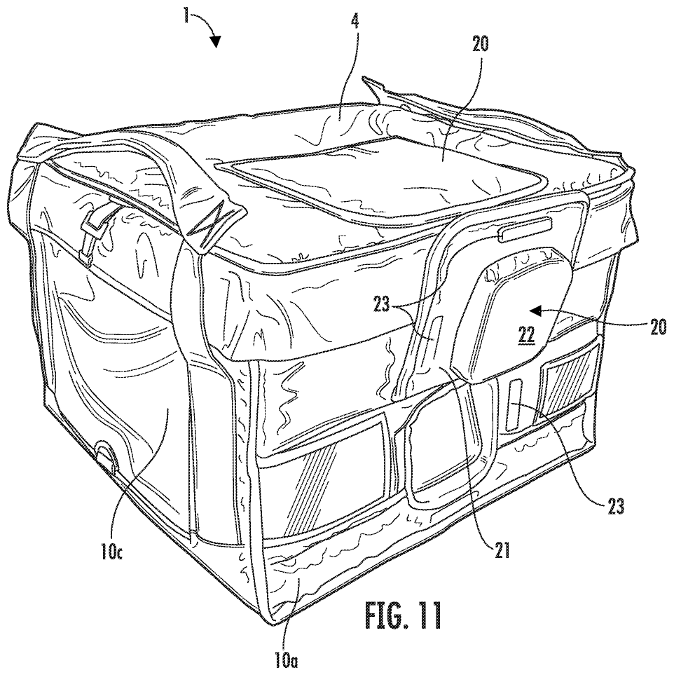

Systems described herein can further comprises one or more covers or doors disposed on an exterior surface. The cover is positioned adjacent to the opening of the interior compartment. In some cases, the cover is hingedly connected to the exterior surface of the system. For example, one edge of the cover can be stitched, glued, or otherwise attached to, integrated with, or formed from the exterior surface of the system. The cover can have the same construction as the side walls, such as an exterior fabric layer, an interior fabric or plastic layer, and, optionally, an intermediate foam layer. FIGS. 1-3 show two exemplary covers 20 in a closed position, where covers 20 extend across an opening in side wall 10a and an opening in lid 4. FIGS. 11, 12, and 14 show embodiments where cover 20 is in an open position, providing access to opening 6 in side wall 10a. FIGS. 8, 13, and 14 show embodiments where cover 20 is in an open position, providing access to opening 6 in lid 4. FIG. 14 specifically shows an embodiment where covers 20 are both in an open position, providing access to opening 6 in side wall 10a and an opening 6 in lid 4.

As shown in FIGS. 11-15, covers 20 described herein can have a flange portion 21 circumferentially extending around the periphery of the internal surface of the cover. When in the closed position, the flange portion contacts the exterior surface of the side wall or lid. In some embodiments, a projection 22 is formed on a central region of the internal surface and projects outward therefrom. This outward projection can be formed in some cases from the intermediate foam layer and the interior fabric or plastic layer. Typically the projection 22 has a shape that is complimentary to the shape of the opening, such that when the cover is in the closed position, the projection fits into the opening to provide insulation in the opening and prevent or reduce heat loss from the interior compartment of the system. In some embodiments, the projection has a thickness that is approximately equal to a thickness of the side wall or lid the opening is form in.

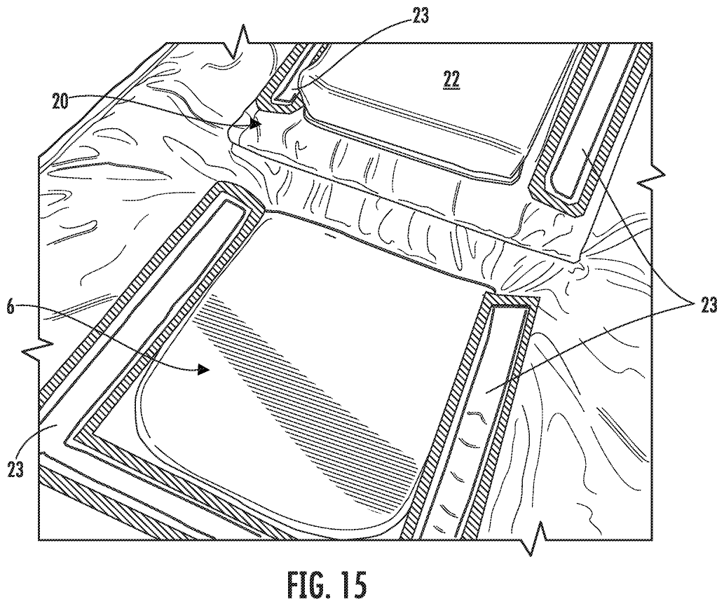

Covers described herein can be releasably connected to the exterior surface of the system when in the closed position through any mechanism not inconsistent with the objectives of this disclosure. In a preferred embodiment, the cover is releasably connected to the exterior surface of the system through magnets. For example, as shown in FIGS. 11-15, magnets 23 can be disposed at defined or predetermined intervals along the flange portion of cover 20, or, in a more preferred embodiment shown in FIG. 15, the magnets can be disposed continuously around one, two, or three sides of flange portion 22. Corresponding magnets can be positioned on (or beneath) the exterior surface of the system, such that when the cover is in a closed position, a magnetic seal is formed between the cover and system, creating a positive fitting closure. It is to be understood that the magnets can be disposed on an exterior surface or beneath the surface and within the material forming the surface (e.g., between two fabric layers).

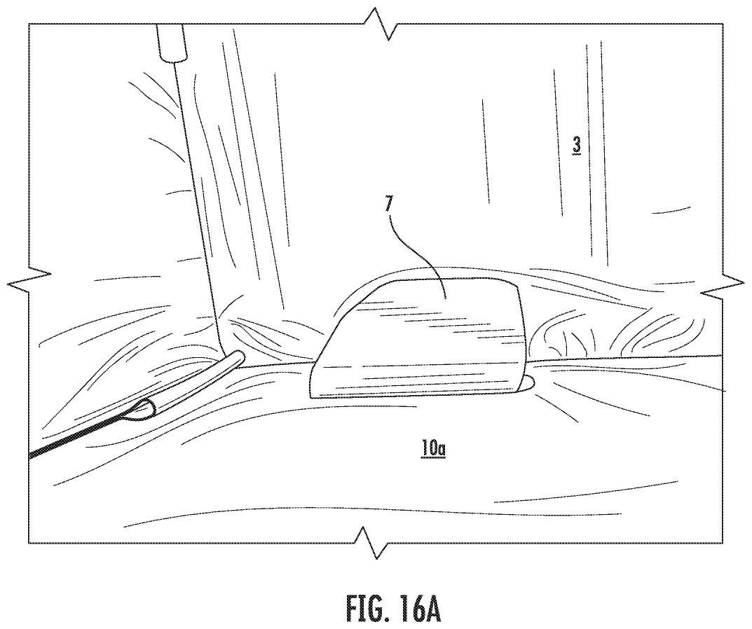

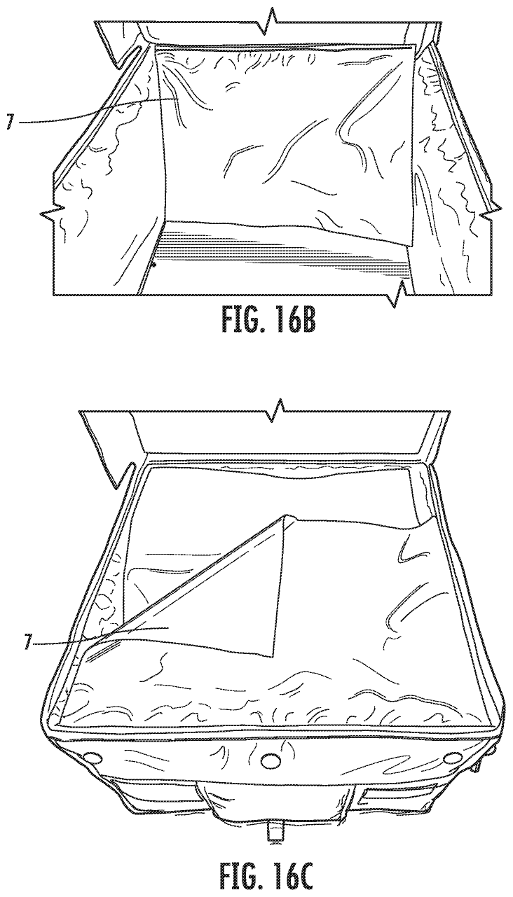

Systems described herein can further comprise a flap, apron, or tongue disposed within the interior compartment and positioned adjacent to the opening of the interior compartment. In some cases, the flap is attached to the side walls or lid of the interior compartment, but is not attached to the floor of the interior compartment. In such instances, the flap hangs from the side walls or lid. For example, in some cases, a top edge or portion of the flap is stitched, glued, or otherwise attached to, integrated with, or forms unitary part of the top of a side wall, but no other edge or portion of the flap is stitched, glued, or otherwise attached to any portion of the interior compartment. FIG. 16A illustrates an embodiment wherein flap 7 is integrally formed from an interior surface of a first side wall 10a. FIG. 16B illustrates an embodiment wherein flap 7 is stitched to the top of a first side wall 10a. FIG. 16C illustrates a perspective view in which flap 7 is shown extended upward (as opposed to hanging loose toward the floor of the interior compartment).

In some embodiments, the flap covers the entirety or at least 90% of the entirety of the opening on the interior compartment side of the opening (as opposed to covering the opening from the outside or exterior environment side of the food transport system). As shown in FIG. 16B, in some embodiments, the flap hangs over or below the opening, e.g., by extending or hanging all the way down to the floor of the interior compartment. In other instances, the flap covers at least 90%, at least 95%, or at least 99% of the opening, but not necessarily the entirety of the opening.

The flap can be formed of any material that is not inconsistent with the objectives of this disclosure. In some embodiments, the flap is formed from an air-impermeable material, such a fabric, foam, and/or plastic. In some embodiments, the flap is formed from one or more of the components forming the side walls, as previously described herein. Such a flap, in some cases, can thus form or define an air cushion or region of air in between the opening (and the exterior environment) and the objects (e.g., hot food) stored or transported within the interior compartment, particularly when the major plane of the flap is disposed very close to the plane of the opening, such as within 3 cm, within 2 cm, within 1 cm, within 0.5 cm, or less than 0.5 cm.

In some cases, inclusion of the flap provides a built-in mitt or barrier, to protect the hand of the user from contacting a hot shelf (described in more detailed below) positioned in the internal volume.

As described further herein, inclusion of a flap in a food transportation system of the present disclosure can be especially preferred when the overall food transportation system is collapsible. In some embodiments, certain seams or fold lines are used to allow the food transportation system to be collapsed in the vertical or z-dimension. Not intending to be bound by theory, it is believed that such seams or fold lines can reduce the thermal insulation properties of the system, particularly when the system is in its uncollapsed or extended configuration, which is the configuration typically used for food transportation. As previously described, the seams or fold lines can in some instances define or are formed by thinner regions of material, as measured in the dimension extending from the exterior environment to the interior compartment of the food delivery system (e.g., the thickness of a side wall). The presence of a flap described herein can allow the food transportation system to maintain a higher thermal insulation than would otherwise be possible, given the presence of seams or fold lines (e.g., as measured by an R-value of the lid, side walls, and/or floor of the interior compartment). In some embodiments, for instance, a food transportation system comprising a flap as described herein has an R-value (or other thermal insulation property) that is at least 130%, at least 150%, or at least 200% of an R-value (measured in the same manner) of an otherwise identical food transportation system. In some cases, a food transportation system comprising a flap as described herein has an R-value (or other thermal insulation property) that is 130-300%, 130-250%, or 130-200% of an R-value (measured in the same manner) of an otherwise identical food transportation system.

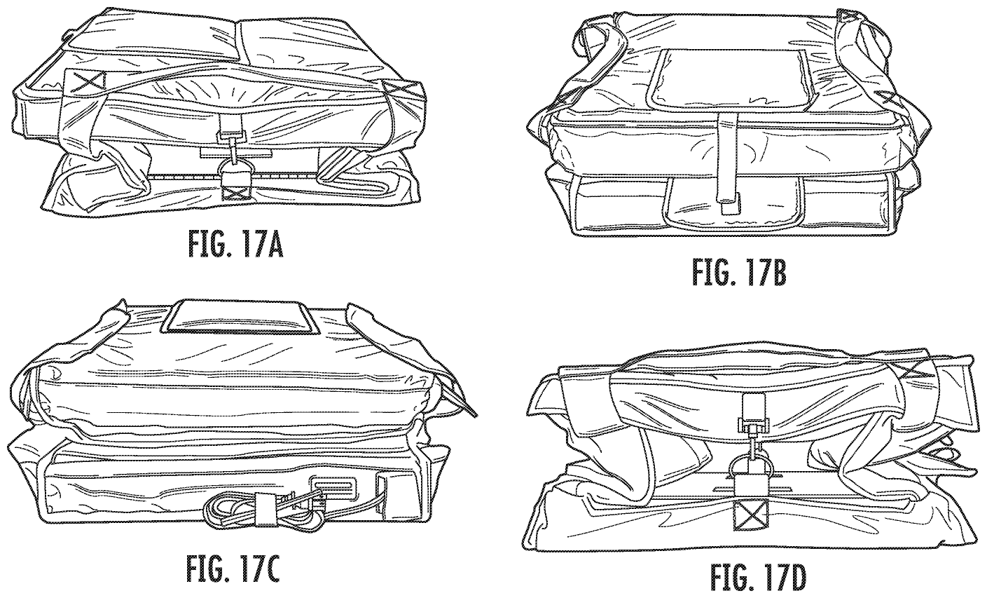

In some embodiments, a system described herein can comprise one or more fastening mechanisms to hold or fix the system in the closed, collapsed configuration shown, for example, in FIG. 7C. Any fastening mechanism not inconsistent with the objectives of this disclosure can be used. For example, a ring and clasp or velcro strap can be used, as shown in FIGS. 17A-17D. In the embodiments shown in FIGS. 17A-17D, a ring and clasp is used on the third and fourth side walls 10c,10d (FIGS. 17A and 17D, respectively). If desired, a velcro strap or other fastening mechanism can also be used on the first side wall 10a or the second side wall 10b. The embodiment shown in FIGS. 17A-17D should be understood to merely be exemplary, and any other combination of fastening mechanism types or quantity can be used.

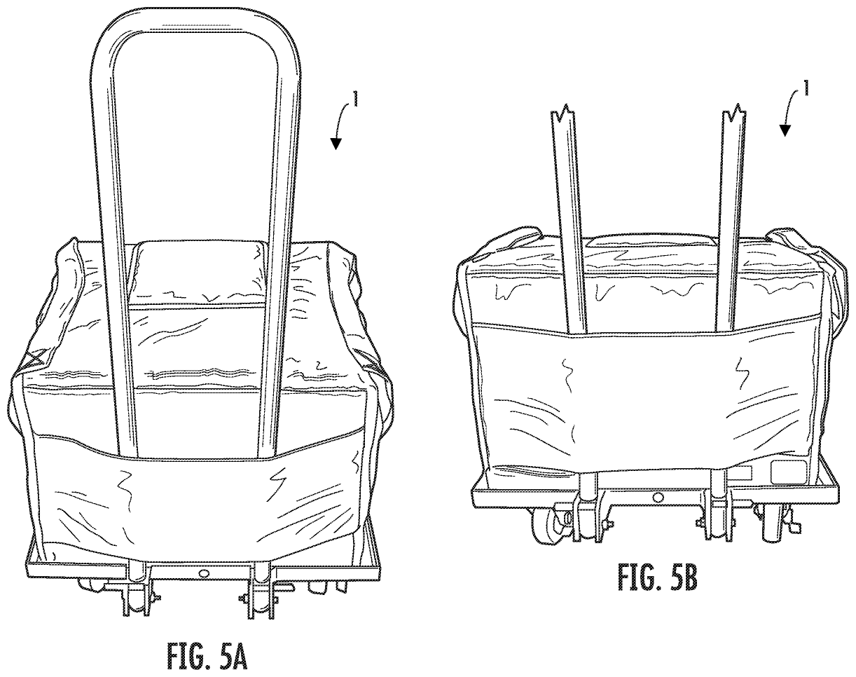

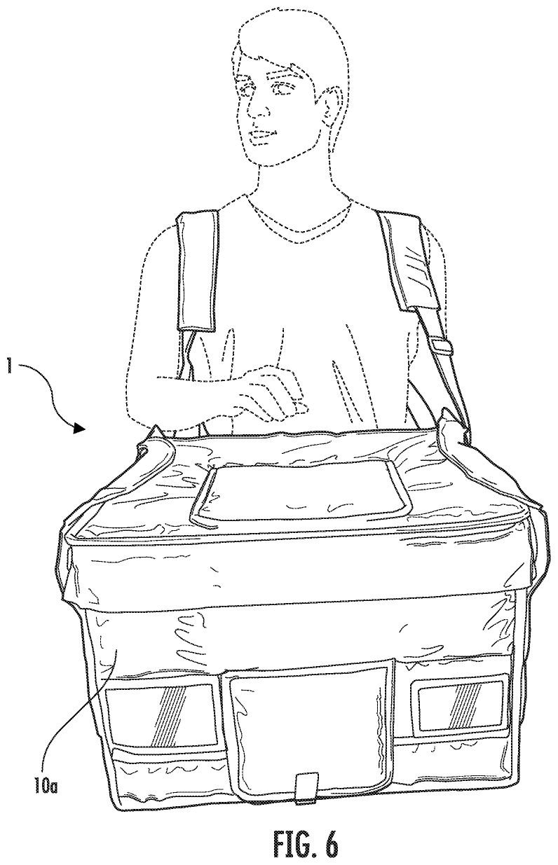

In addition, in some embodiments, a system described herein comprises straps for holding, supporting, or carrying the system, as illustrated in FIG. 6. In some such embodiments, the straps are sewed, stitched, or otherwise attached to an exterior surface of the system (e.g., a side wall surface). Moreover, in some cases, the system comprises a pouch for storing the straps when not in use, such as shown in FIG. 8, where the pouch is disposed on side wall 10b and can also be used to receive a handle (e.g., of a cart or hand truck used to transport the system or a plurality of systems, as illustrated in FIGS. 5A and 5B.

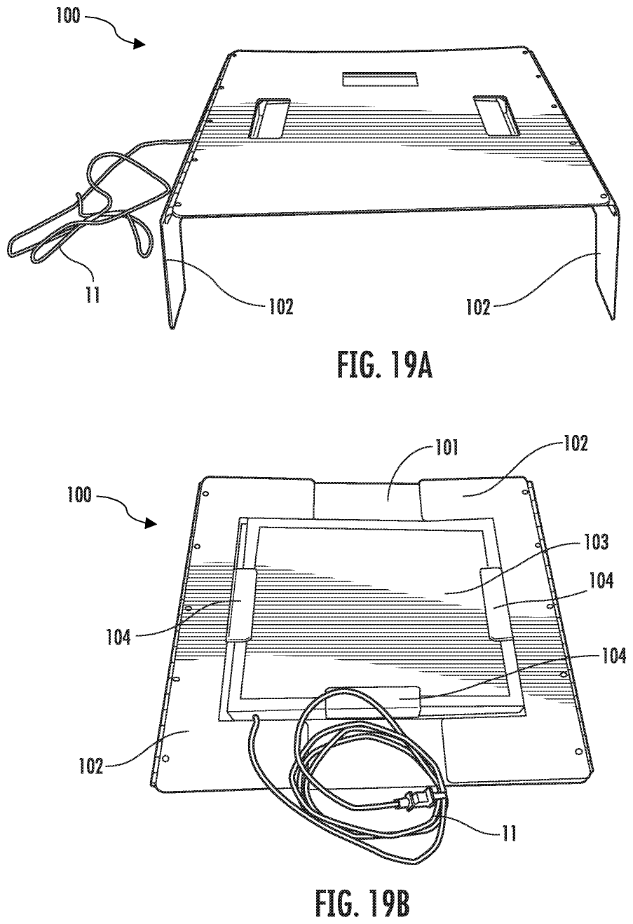

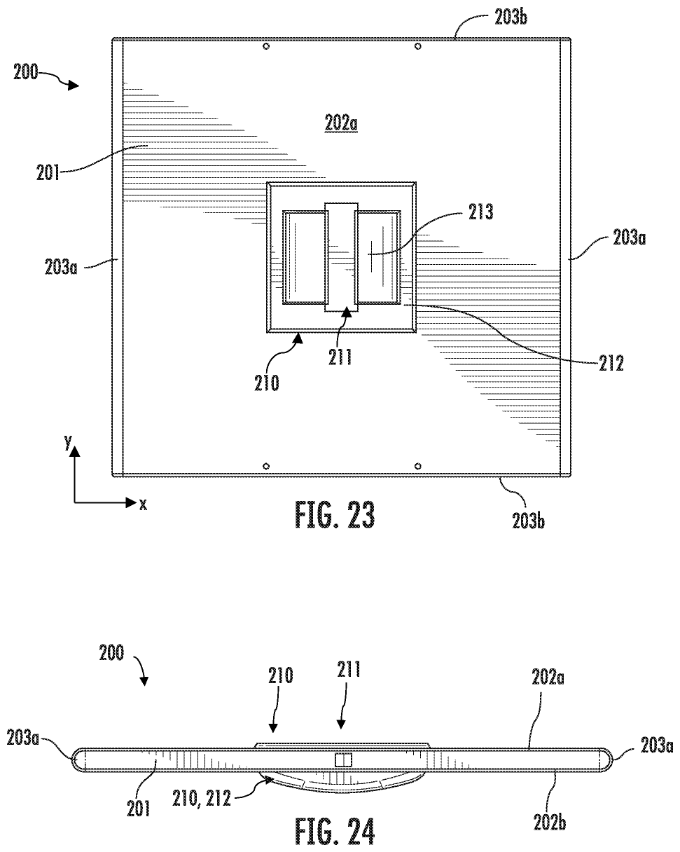

Systems described herein can further comprise a shelf disposed within the interior volume. In some embodiments, the shelf divides the interior volume into a top portion and bottom portion. In some instances, the shelf comprises a top surface extending horizontally (in two dimensions) within the interior volume. In some embodiments, the shelf extends in the horizontal plane across the entire interior volume, such that the shelf fully “covers” the bottom portion of the interior volume. In other cases, the shelf extends in the horizontal plane and covers at least 85%, at least 90%, or at least 95% of the total planar area of the interior volume at the location of the shelf. In practice, a first food, portion of food, or any other desired product can be placed in the top portion, above or on the shelf, and a second food, portion of food, or any other desired product can be placed in the bottom portion, beneath the shelf. FIGS. 19A, 19B, and 23-30 show different exemplary shelfs 100, 200. The embodiments of shelf 200 shown in FIGS. 23-30 are described in more detail herein in Section II.

In the embodiment shown in FIGS. 19A and 19B, a shelf 100 described herein comprises a bottom surface 101 and two legs 102 extending substantially orthogonally from a bottom surface or opposite edges of shelf 100. The two legs 102 can be connected or attached to the bottom surface or opposite edges of the shelf. Thus, the legs can be foldable, including by 90 degrees, such that the legs contact or “lie flat” against the bottom surface when the legs are “folded under” the shelf. In some cases, the two legs are attached to the bottom surface with hinges, as illustrated in FIG. 19A and FIG. 19B. In some cases, the shelf further comprises hinge stops to prevent the hinges from extending more than 90 degrees (i.e., from “unfolding” beyond 90 degrees, such that the hinged legs and the top surface of the shelf would all be coplanar, rather than the legs being disposed beneath the top surface). Such hinge stops or hinge locks may also “lock” the legs in place (e.g., at 90 degrees) once the legs are extended to support the top surface of the shelf. As described further herein, such a shelf can be folded flat. Thus, when the interior volume of the system is collapsed in the vertical direction, the shelf can remain within the interior volume without significantly hindering the overall collapsibility of the system. In addition, in some embodiments, the floor or the interior compartment of a system described herein comprises or defines a recess or depression having a size and shape that matches or corresponds to the bottom side of a folded or collapsed shelf, such that a bottom portion of the shelf fits into the depression or recess. Additionally, in some cases, the floor of the interior compartment comprises or defines narrow grooves or slots that correspond to the size of the legs of a shelf described herein when the legs are deployed and the self is upright, such that the legs slide into and are at least partially secured by the grooves, thus improving the stability of the shelf.

Moreover, in some instances, a shelf described herein comprises finger gripping holes (which may be coated with rubber or another thermally insulating material, for instance) disposed in the top surface of the shelf, such that a user can grip and lift or otherwise manipulate the shelf without touching the top surface or legs of the shelf directly, which may be hot.

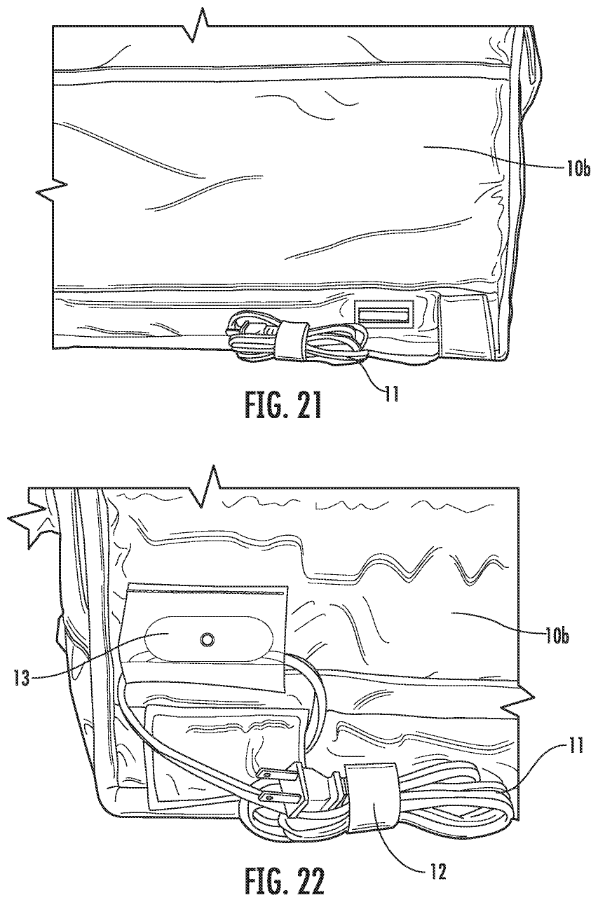

Shelf 100 can further comprise a heater or heating element 103 positioned on the bottom surface 101 or top surface 104. The exemplary heating element 103 shown in FIG. 19B slides into and is held in place by receiving tabs 104 on the bottom surface 101 of shelf 100. The heater 103 of FIG. 19B, or another heater (which can be of any type not inconsistent with the objectives of the present disclosure), can produce heat by being plugged in with a power cord, such as power cord 11 shown for example in FIGS. 21 and 22. In FIG. 21, power cord 11 passes through second side wall 10b to connect to shelf 100, or shelf 200 described in Section II herein. In some cases, a cord retaining strap 12 is positioned on an exterior surface of second side wall 10b, and allows for storage and retention of power cord 11.

Moreover, in some embodiments, the heating element comprises or is in thermal contact with a phase change material (such as a phase change material described further in Section II or Section IV hereinbelow). Such a heating element can be used for actively heating the interior volume and/or for inducing a phase transition in the phase change material, thereby “charging” the phase change material and storing thermal energy as latent heat, which latent heat can subsequently be used for “passively” heating or maintaining a desired temperature within the interior volume.

In some embodiments, shelves (or the heating element of a shelf) described herein can be powered by a battery (not shown), allowing the system to be remotely powered without needing to be plugged in. This can be an advantage during transport of the system, or for a situation where external power is unavailable. In some cases, shelves described herein can optionally be powered by both a battery and an external power source.

Additionally, in some cases, systems described herein comprise a thermal status indicator. In some embodiments, the thermal status indicator 13 is integrated with power cord 11, as illustrated in FIG. 22. The thermal status indicator provides a visual and/or auditory indication related to the heating status of a shelf, heating element, or phase change material described herein. For instance, for a visual thermal status indicator, when the shelf is first plugged in, an indicator light can glow or emit a first color (e.g., red), and when the shelf is fully heated, the indicator light can glow or emit a second color (e.g., green) to reflect the heat status or “readiness” of the shelf, heater, phase change material, or overall system. Similarly, the thermal status indicator can emit a first sound when the system, shelf, heater, or phase change material is heating or “charging,” and a second sound when the system, shelf, heater, or phase change material is fully heated or “charged,” based on a desired set point or thermostat setting. In some cases, the indicator light is coupled to a thermometer or thermostat in the internal compartment, and provides indications reflecting a temperature in the internal compartment.

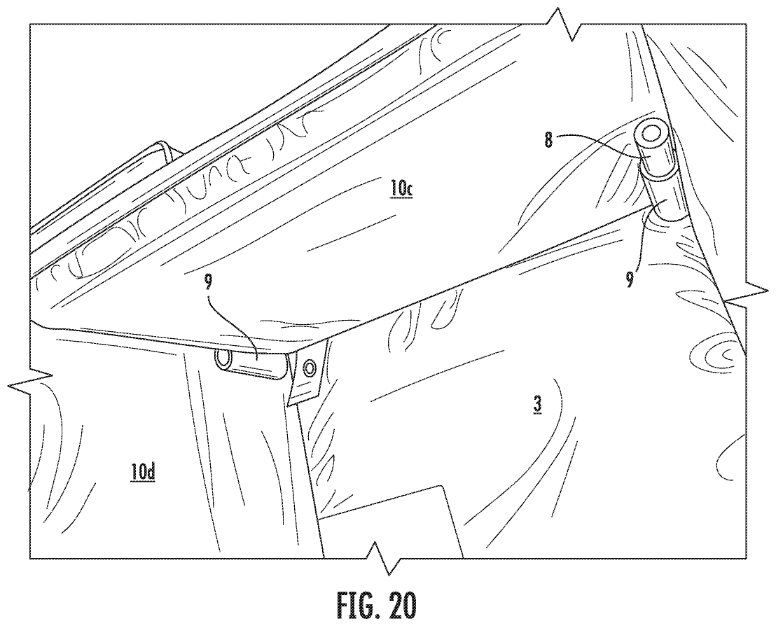

In the embodiments shown in FIGS. 23-30, shelf 200 is substantially planar or flat. When shelf 200 (or another shelf that does not have its own legs) is used in system 1, system 1 can further comprise a plurality of rigid posts disposed within the interior volume, such as rigid posts 8 shown in FIG. 20. The number of rigid posts used in the system can comprise 2, 3, 4, 5, 6, or more than 6 rigid posts. The rigid posts can be positioned substantially orthogonal to the floor and the shelf is configured to rest on and/or be coupled or attached to the rigid posts. The rigid posts 8 can be disposed in sleeves 9 defined in or formed from one or more side walls. Sleeves 9, in some preferred embodiments, are formed from an elastic material that be expanded to receive the posts 8 and can relax and help retain posts 8 after placing posts 8 in sleeves 9.

In some preferred embodiments, each of two moveable side walls comprises two sleeves and two posts, at opposite sides/edges, such that four total posts are provided, one at each corner of the box-like interior volume or compartment. In such an instance, the posts can be moved into a flat or horizontal position (as opposed to a vertical position) when the side walls are moved as described herein (e.g., in FIGS. 7A-C).

The rigid posts described herein can be formed from any material not inconsistent with the objectives of this disclosure. Exemplary materials include a metal or a plastic.

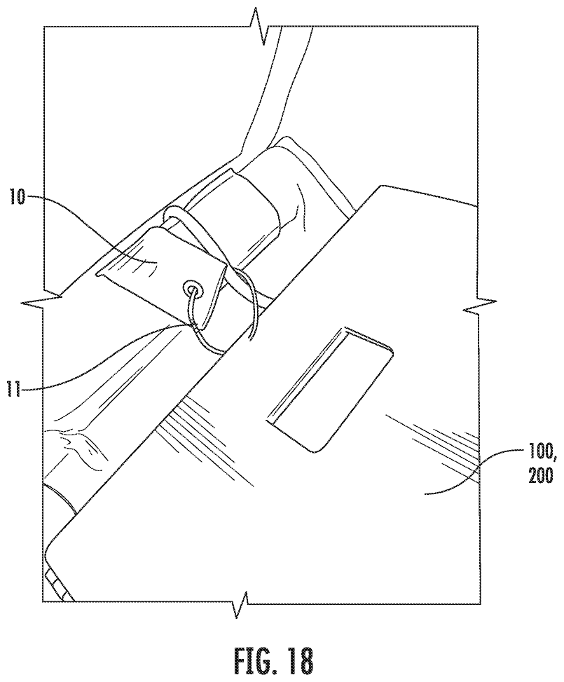

Systems described herein can further comprise a tether attaching a side wall or the floor of the interior volume to the shelf. In some embodiments, for instance and as illustrated in FIG. 18, a tab 10 with an eyelet is disposed within the interior volume and a coupling member 11 is engaged to the eyelet of the tab and with a portion of the shelf 100,200. For example, in some cases, the shelf also comprises an eyelet for coupling to the coupling member. Exemplary coupling members can include a tie, chain, rope, wire, thread, yarn, filament, or other similar material.

### II. Heater/Shelf

In another aspect, heaters are described herein. Such a heater, in some embodiments, can also function as a shelf for use in a food transportation system described herein. One non-limiting example of a heater or shelf 200 described herein is illustrated in FIGS. 23-27. For purposes of clarity, the heater or shelf described in this section will be referred to as a “shelf” With reference to the figures, a shelf 200 comprises a housing 201 having a top surface 202a, a bottom surface 202b in facing opposition to the top surface 202a, a first set of opposing side surfaces 203a, and a second set of opposing side surfaces 203b. These sides or surfaces, especially including the top surface and the bottom surface, can together define a “skin” of the housing. Moreover, in some cases, the first set of opposing side surfaces 203a connect the top surface 202a to the bottom surface 202b, and the second set of opposing side surfaces 203b also connects the top surface 202a and the bottom surface 202b. Additionally, in some embodiments, the top surface 202a, the bottom surface 202b, the first set of opposing side surfaces 203a, and/or the second set of opposing side surfaces 203b are substantially planar surfaces, such that the housing is or forms a substantially rectangular cylinder or prism. A surface that is substantially planar, for reference purposes herein, is planar across at least 85% or at least 90% of its surface, on a total area basis, in the sense that at least 85% or at least 90% of the area of the surface forms a smooth or flat plane, as opposed to an undulating, curved, or angular plane. The remaining area (up to 15% or up to 10%) may be curved or otherwise non-flat or non-smooth. For example, in the embodiment shown in FIGS. 23-27, the top surface 202a, the bottom surface 202b, and the second set of opposing side surfaces 203b are substantially planar surfaces that (in the case of the top and bottom surfaces) include slight curves at their extremities, thereby forming two rounded edges of the housing 201.

It should further be noted that, in the embodiment illustrated in FIGS. 23-27, the top surface 202a, the bottom surface 202b, and the second set of opposing side surfaces 203b form 90 degree angles with their immediately adjacent surfaces (neglecting or ignoring the curves of the rounded edges). However, in other implementations, other angles might be formed. For example, in some cases, the first set of opposing side surfaces 203a and/or the second set of opposing side surfaces 203b are slanted inwardly or outwardly between the top surface 202a and the bottom surface 202b, such as may occur when the top surface 202a and the bottom surface 202b are parallel to one another but have different sizes or planar areas or planar extents.

The top surface 202a, bottom surface 202b, first set of opposing side surfaces 203a, and second set of opposing side surfaces 203b can be joined or attached to another in any manner not inconsistent with the objectives of the present disclosure. For example, in some implementations, one or more of the foregoing surfaces or sides are welded, glued, adhered, or taped together. In other cases, one or more of the foregoing surfaces or sides are attached or joined by one or more fasteners, such as one or more rivets, screws, or pins. One or more surface or sides may also be joined or attached through a male-female connection, such as may be formed by placing pins or protrusions of one surface or side within holes, receptacles or tabs associated with an adjacent surface or side. In some such cases, a side surface can be “snapped” into or in between the top surface and bottom surface. It is also possible, in some instances, for one or more sides to be formed from a single unitary or monolithic material that has been bent or folded, such as through a metal folding or bending process. Moreover, in some embodiments, a housing of a heater/shelf described herein comprises sides that are joined or attached by a combination of two or more of the above. For example, in some cases, the top and bottom surfaces are formed from folded metal (with or without a seam or weld or other connection where the folded metal sheet “meets” or connects with itself), and one or more of the side surfaces are welded, glued, adhered, taped, riveted, screwed, or pinned to the top and/or bottom surface.

In addition, the housing (or one or more sides or surfaces thereof) can be formed from any material not inconsistent with the objectives of the present disclosure. For example, in some cases, the housing (or one or more sides or surfaces thereof) is formed from a thermally conductive material such as a metal or mixture, combination, or alloy of metals. In some preferred embodiments, for instance, the top surface and the bottom surface of the housing are formed from aluminum. A composite material (such as a fiberglass or carbon fiber composite) may also be used to form one or more portions of the housing. Other materials may also be used. In some preferred embodiments, however, at least the top surface and the bottom surface of the housing are formed primarily from a thermally conductive material, such that heat generated by the heater is readily transmitted to items in contact with or disposed near the top and bottom surfaces of the heater/shelf. It is further to be understood that any thermally conductive material not inconsistent with the objectives of the present disclosure may be used, and that such a “thermally conductive material” can include any material that is recognized by a person having ordinary skill in the art as being a thermal conductor rather than a thermal insulator. In some embodiments, however, other sides or surfaces of the housing (other than the top and bottom surfaces) may be formed from a non-thermally conductive material or from a thermally insulating material, such as a plastic or ceramic material.

Turning again to FIGS. 23-27, a heater/shelf described herein further comprises a handle assembly 210 disposed on the top surface 202a. Moreover, the handle assembly 210 comprises a gripping portion 211 and a base portion 212, which together define a recessed area 213. The handle assembly 210 can be used to lift, move, or otherwise manipulate the overall heater/shelf 200. For example, a human user of the heater/shelf 200 can grip the gripping portion 211 of the handle assembly 210 with her fingers/hand. The recessed area 213 between the gripping portion 211 and the base portion 212 can receive the user's fingers and shield or separate the user's fingers from the top surface 202a of the heater/shelf 200, which may be hot. In addition, in some embodiments, such as that illustrated in FIGS. 23-27, the gripping portion 211 of the handle assembly 210 is flush or substantially flush with the top surface 202a of the housing 201. A handle assembly that is “substantially” flush with a surface can extend no more than 2 centimeters (cm), no more than 1 cm, or no more than 0.5 cm above the plane of the surface.

Moreover, the handle assembly, in some preferred embodiments, is not coextensive with the plane of the top surface of the housing. That is, the handle assembly occupies less than the total area of the top surface. In some cases, for example, the handle assembly occupies no greater than 25%, no greater than 20%, no greater than 15%, no greater than 10%, or no greater than 5% of the area of the top surface. In some preferred embodiments, the handle assembly occupies between 3% and 25%, between 3% and 20%, between 5% and 20%, between 5% and 15%, between 10% and 25%, or between 10% and 20% of the area of the top surface. A handle assembly having such a size can provide adequate protection to the hand of a user while also leaving a large majority of the top surface uncovered and thus available for distributing heat to items on or near the top surface of the housing of the heater/shelf. Additionally, in some preferred embodiments, the handle assembly of a heater/shelf described herein is centered on the top surface of the housing, in both the x-direction and the y-direction of the major plane of the top surface (where the z-direction would be orthogonal to the major plane of the top surface).

Further, in some cases, such as that illustrated in FIGS. 23-27, the handle assembly 210 passes or extends through both the top surface 202a and the bottom surface 202b of the housing 201. Alternatively, in other instances, the handle assembly is disposed on the top surface or extends through the top surface of the housing, but does not extend through the bottom surface of the housing. It is further to be understood that the “top” surface of a housing described herein can be distinguished from the “bottom” surface of a housing described herein based on which side of the housing includes the gripping portion of the handle assembly. In such an instance, the surface or side including the gripping portion can be defined as the “top” surface or side.

With reference once more to FIGS. 23-27, the illustrated embodiment of a heater/shelf 200 includes a handle assembly 210 that passes through both the top surface 202a and the bottom surface 202b. A base portion 212 of the handle assembly 210 extends between the top surface 202a and the bottom surface 202b of the housing 201. Moreover, in the embodiment of FIGS. 23-27, the bottom of the base portion 212 is curved instead of flat. Thus, the heater/shelf 200, when resting on the base portion 212 of the handle assembly 210, can “rock” on the base portion 212. Further, in some preferred embodiments in which a heater/shelf described herein is used with, or forms part of, a food delivery system described herein (e.g., in Section I hereinabove), the base portion 212 of the handle assembly 210 can have a size and/or shape that matches the shape of a recess in the floor of the interior compartment of the food delivery system, as described further in the present disclosure. For example, some preferred embodiments, the height or thickness of the bottom portion of the handle assembly can be the same as, or within 20% of, the depth of the recess in the floor of the interior compartment, such that when the heater/shelf is placed on the floor of the interior compartment, the bottom portion of the handle assembly fits into the recess in the floor and the major plane of the overall heater/shell is parallel with the floor of the interior compartment and “sits” in the interior compartment in a level manner, as opposed to a slanted manner.

The handle assembly (or portion thereof) can be formed from any material not inconsistent with the objectives of the present disclosure. In some embodiments, for instance, the entire handle assembly or a portion thereof (e.g., the gripping portion) is formed from a thermally insulating material, such as plastic or rubber. Moreover, in some cases, the handle assembly and, more particularly, the gripping portion of the handle assembly, is not formed from a thermally conductive material, such as metal. Further, in some embodiments, the entire handle assembly or a portion thereof is formed from a material that has high heat resistance, such as a material that does not melt or soften below 100° C. In some cases, the material forming the handle assembly does not melt or soften below 110° C.

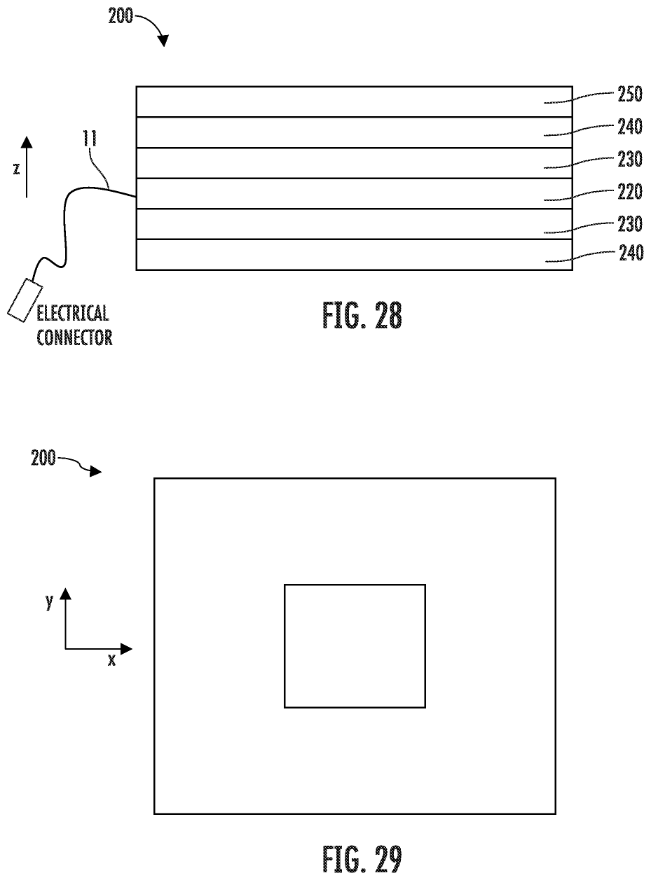

In addition, in some cases, a heater or shelf described herein further comprises a heat generation layer (or a plurality of heat generation layers) disposed within the housing. One non-limiting example of such a heat generation layer is illustrated in FIGS. 28-30. As illustrated in FIGS. 28-30, the heat generation layer 220, in some preferred embodiments, has a planar or sheet-like structure, where the sheet-like structure has one relatively short dimension (e.g., the thickness or z-direction) and two relatively long dimensions (e.g., the lateral dimensions, such as length and width, or the x- and y-directions). Other layers shown in FIGS. 28-30 will be further described below. In addition, it is to be noted that the stack of layers illustrated in FIGS. 28-30 can be disposed within the housing of any heater/shelf described herein, including the embodiment illustrated in FIGS. 23-27.

A heat generation layer, such as heat generation layer 220 in FIGS. 28-30, can comprise or be formed from any material and operate by any principle not inconsistent with the objectives of the present disclosure. For example, in some cases, a heat generation layer comprises one or more heating elements, particularly one or more resistive heating elements that generate thermal energy through the passage of an electric current through an electrically conductive material. Such resistive heating elements are known to a person of ordinary skill in the art and can include, for instance, circuits formed from a metal. Moreover, in some embodiments, a heat-generation layer of a heater/shelf described herein further comprises one or more mica sheets. Such mica sheets can be in contact with the resistive heating elements and/or can be heated by the resistive heating elements. Other materials may also be used in a heat generation layer of a heater/shelf described herein.

In addition, a heat generation layer can have any thickness not inconsistent with the objectives of the present disclosure. In some embodiments, for instance, the heat generation layer (or stack of heat generation layers) has a thickness (in the z-direction) of no greater than 5 cm or no greater than 3 cm. In some cases, the heat generation layer (or stack of heat generation layers) has a thickness of 0.5-5 cm, 0.5-3 cm, 1-5 cm, or 1-3 cm.

Further, the heat generation layer of a heater/shelf described herein, in some implementations, is coextensive or substantially coextensive with the plane of the top surface of the housing, as illustrated, for instance, in FIGS. 28-30. In some embodiments, for example, the planar area of a top side of the heat generation layer is up to 99%, up to 95%, up to 90%, up to 85%, or up to 80% of the planar area of the top surface. In some cases, the planar area of a top side of the heat generation layer is 70-100%, 70-99%, 70-95%, 70-90%, 80-100%, 80-99%, 80-95%, 80-90%, 85-100%, 85-99%, 85-95%, 85-90%, 90-100%, 90-99%, or 90-95% of the planar area of the top surface. Further, it is to be understood that, in some cases, the heat generation layer comprises a hole, aperture, or opening corresponding to the area of the handle assembly of the heater/shelf. For example, in the embodiment illustrated in FIGS. 28-30, the heat generation layer 220 comprises a hole 221 corresponding to the handle assembly 210. Such a structure can permit placement of the handle assembly 210 in a position described herein while also providing a desired heating profile. For instance, in some embodiments described herein, a heat generation layer provides a heating gradient, such as a heating gradient in which more heat is provided from the perimeter or corners of the heat generation layer, as opposed to from the center of the heat generation layer. Such a heating gradient can be especially preferred when a heater or shelf described herein is used with or as part of a food delivery system described herein.

It is further to be understood that a heater or shelf described herein can comprise one or more electrical connectors, one or more thermostats, and/or one or more temperature sensors. Such electrical connectors, thermostats, and/or sensors can be associated with the heat generation layer of the heater/shelf, including in a manner that permits the heat generation layer to be turned on or off as desired, either manually or automatically (such as based on a desired set point of a thermostat). Moreover, the electrical connectors, thermostats, and/or sensors can be placed in any location within the housing not inconsistent with the objectives of the present disclosure, and the location is not particularly limited.

Turning again to FIGS. 28-30, a heater or shelf described herein, in some embodiments, further comprises a heat spreading layer (or a plurality of heat spreading layers) disposed within the housing. Such a heat spreading layer (or stack of such layers), in some cases, is disposed immediately adjacent to and in thermal and/or physical contact with a heat generation layer of the heater/shelf. Not intending to be bound by theory, it is believed that a heat spreading layer described herein can help distribute thermal energy provided by the heat generation layer to the skin of the housing of the heater/shelf, including in a manner that is more uniform across the surface of the skin or that more closely achieves a desired heat flux gradient or heat flux pattern or profile over the skin of the housing, as compared to in the absence of a heat spreading layer. Such distribution of thermal energy by the heat spreading layer can also be provided to other layers disposed within the housing, such as one or more heat sink layers, which are further described below.

One non-limiting example of a heat spreading layer is illustrated in FIGS. 28-30. As illustrated in FIGS. 28-30, an optional heat spreading layer 230, in some preferred embodiments, has a planar or sheet-like structure. Moreover, in the embodiment of FIGS. 28-30, a plurality of heat spreading layers 230 are disposed within the housing, including a first heat spreading layer above the heat generation layer 220 (toward the top surface of the housing) and a second heat spreading layer below the heat generation layer 220 (toward the bottom surface of the housing)

Further, a heat spreading layer of a heater/shelf described herein, in some implementations, is coextensive or substantially coextensive with the plane of the top surface of the housing and/or with an adjacent heat generation layer, as illustrated, for instance, in FIGS. 28-30. In some embodiments, for example, the planar area of a top side of the heat spreading layer is up to 99%, up to 95%, up to 90%, up to 85%, or up to 80% of the planar area of the top surface or of the heat generation layer. In some cases, the planar area of a top side of the heat spreading layer is 70-100%, 70-99%, 70-95%, 70-90%, 80-100%, 80-99%, 80-95%, 80-90%, 85-100%, 85-99%, 85-95%, 85-90%, 90-100%, 90-99%, or 90-95% of the planar area of the top surface or of the heat generation layer. Further, it is to be understood that, in some cases, the heat spreading layer comprises a hole, aperture, or opening corresponding to the area of the handle assembly of the heater/shelf. For example, in the embodiment illustrated in FIGS. 28-30, the heat spreading layer 230 comprises a hole 231 corresponding to the handle assembly 210. Such a structure can permit placement of the handle assembly 210 in a position described herein while also providing a desired heating profile or skin surface temperature profile.

A heat spreading layer can be formed from any material not inconsistent with the objectives of the present disclosure. In some preferred embodiments, the heat spreading layer is formed from a thermally conductive material, such as a metal or combination, mixture, or alloy of metals. In other cases, the heat spreading layer is formed from mica or from a composite material.

In addition, a heat spreading layer can have any thickness not inconsistent with the objectives of the present disclosure. In some embodiments, for instance, the heat spreading layer (or stack of heat spreading layers) has a thickness (in the z-direction) of no greater than 3 cm, no greater than 1 cm, or no greater than 0.5 cm. In some cases, the heat spreading layer (or stack of heat spreading layers) has a thickness of 0.1-3 cm, 0.1-1 cm, 0.1-0.5 cm, or 0.1-0.3 cm.

With reference once more to FIGS. 28-30, a heater or shelf described herein, in some embodiments, further comprises a heat sink layer (or a plurality of heat sink layers) disposed within the housing. Such a heat sink layer (or stack of such layers), in some cases, is disposed immediately adjacent to and in thermal and/or physical contact with a heat spreading layer of the heater/shelf. A heat sink layer may also be immediately adjacent to and in thermal and physical contact with the skin of the housing (e.g., the top surface or the bottom surface of the housing). Not intending to be bound by theory, it is believed that a heat sink layer described herein can store or slow the distribution of thermal energy provided by the heat generation layer. The heat sink layer can then release or transmit that thermal energy over time to the skin of the housing of the heater/shelf. In this manner, a heat sink layer described herein can provide a desired heat flux to the surface of the skin of the housing, where the heat flux at the surface of the skin is less than the heat flux at the surface of the heat generation layer itself. For example, in some cases, the average heat flux at the surface of the skin (or at the surface of the heat sink layer itself, distal from the heat generation layer) is 10-90%, 10-85%, 10-80%, 10-70%, 10-60%, 10-50%, 20-90%, 20-85%, 20-80%, 20-70%, 20-60%, 20-50%, 30-90%, 30-80%, 30-70%, 30-60%, 30-50%, 30-40%, 40-90%, 40-80%, 40-70%, 40-60%, 50-90%, 50-80%, 50-70%, 50-60%, 60-90%, 60-80%, 60-70%, 70-90%, 70-80%, or 80-90% of the average heat flux at the proximal surface of the heat generation layer (as opposed to at the distal surface of the heat generation layer, where “proximal” and “distal” are relative to the heat sink layer or skin, as the case may be), when measured from 0 to 5 minutes following initiation of heat generation by the heat generation layer and while the heat generation layer is producing heat at a constant rate. Moreover, the foregoing heat flux measurement can be based on direct heat flux measurement at the relevant surfaces using one or more heat flux sensors, or based on indirect heat flux measurement at the relevant surfaces using one or more temperature sensors, as understood by one of ordinary skill in the art.

Non-limiting examples of heat sink layers are illustrated in FIGS. 28-30. As illustrated in FIGS. 28-30, optional heat sink layers 240, in some preferred embodiments, have a planar or sheet-like structure, and can be placed both above and below the heat generation layer. That is, a first heat sink layer can be placed above the heat generation layer (toward the top surface of the housing) and a second heat sink layer can be placed below the heat generation layer (toward the bottom surface of the housing).

Further, a heat sink layer of a heater/shelf described herein, in some implementations, is coextensive or substantially coextensive with the plane of the top or bottom surface of the housing and/or with an adjacent heat spreading layer and/or with a heat generation layer, as illustrated, for instance, in FIGS. 28-30. In some embodiments, for example, the planar area of a top or bottom side of a heat sink layer is up to 99%, up to 95%, up to 90%, up to 85%, or up to 80% of the planar area of the top or bottom surface, of the adjacent heat spreading layer, or of the heat generation layer. In some cases, the planar area of a top or bottom side of the heat sink layer is 70-100%, 70-99%, 70-95%, 70-90%, 80-100%, 80-99%, 80-95%, 80-90%, 85-100%, 85-99%, 85-95%, 85-90%, 90-100%, 90-99%, or 90-95% of the planar area of the top or bottom surface, of the adjacent heat spreading layer, or of the heat generation layer. Further, it is to be understood that, in some cases, the heat sink layer comprises a hole, aperture, or opening corresponding to the area of the handle assembly of the heater/shelf. For example, in the embodiment illustrated in FIGS. 28-30, the heat sink layers 240 comprise holes 241 corresponding to the handle assembly 210. Such a structure can permit placement of the handle assembly 210 in a position described herein while also providing a desired heating profile or skin surface temperature profile.

A heat sink layer can be formed from any material not inconsistent with the objectives of the present disclosure. In some preferred embodiments, the heat sink layer is formed from a material having a high specific heat, or has a high heat capacity or thermal mass (such as a high specific heat capacity, mass heat capacity, or a volumetric heat capacity). Non-limiting examples of materials that can be used to form a heat sink layer described herein include a ceramic such as porcelain or zirconia or a polymeric material such as an ultra-high molecular weight polyolefin (e.g., UHMW polyethylene, or UHMWPE).

In addition, a heat sink layer can have any thickness not inconsistent with the objectives of the present disclosure. In some embodiments, for instance, the heat sink layer (or stack of heat generation layers) has a thickness (in the z-direction) of no greater than 2 cm or no greater than 1 cm. In some cases, the heat sink layer (or stack of heat sink layers) has a thickness of 0.1-2 cm, 0.1-1.5 cm, 0.1-1 cm, 0.2-2 cm, 0.2-1.5 cm, 0.2-1 cm, 0.2-0.5 cm, 0.5-2 cm, 0.5-1.5 cm, or 0.5-1 cm.

It is also possible, in some cases, to supplement or replace a heat sink layer described herein with a phase change material (PCM) layer having similar physical dimensions as described above for a heat sink layer. Such a PCM layer can include any PCM not inconsistent with the objectives of the present disclosure. For example, in some cases, the PCM layer comprises or is formed from a PCM that has a phase transition temperature of 50-100° C., 50-80° C., 50-70° C., 70-100° C., 70-90° C., or 70-80° C. Further, a PCM of a PCM layer described herein can either absorb or release energy using any phase transition not inconsistent with the objectives of the present disclosure. For example, the phase transition of a PCM described herein, in some embodiments, comprises a transition between a solid phase and a liquid phase of the PCM, between a solid phase and a mesophase of the PCM, or between two different solid phases of the PCM. A mesophase, in some cases, is a gel phase. Moreover, in some cases, a PCM or mixture of PCMs has a phase transition enthalpy of at least about 30 kJ/kg or at least about 50 kJ/kg. In other embodiments, a PCM or mixture of PCMs has a phase transition enthalpy of at least about 70 kJ/kg, at least about 100 kJ/kg, at least about 120 kJ/kg, or at least about 150 kJ/kg. In some instances, a PCM or mixture of PCMs has a phase transition enthalpy between about 30 kJ/kg and about 150 kJ/kg, between about 30 kJ/kg and about 80 kJ/kg, between about 50 kJ/kg and about 150 kJ/kg, or between about 50 kJ/kg and about 80 kJ/kg.

In addition, a PCM of a PCM layer described herein can have any composition not inconsistent with the objectives of the present disclosure. In some embodiments, for instance, a PCM comprises an inorganic composition. In other cases, a PCM comprises an organic composition. In some instances, a PCM comprises a salt hydrate. In other embodiments, a PCM comprises a fatty acid, such as a fatty acid having a C4 to C28 aliphatic hydrocarbon tail. For reference purposes herein, it is to be understood that a chemical species described as a “Cn” species (e.g., a “C4” species or a “C28” species) is a species of the identified type that includes exactly “n” carbon atoms. Thus, a C4 to C28 aliphatic hydrocarbon tail refers to a hydrocarbon tail that includes between 4 and 28 carbon atoms. In some embodiments, a PCM comprises an alkyl ester of a fatty acid, such as a methyl ester, ethyl ester, isopropyl ester, butyl ester, or hexyl ester of a fatty acid described herein. In some cases, a PCM comprises a fatty alcohol, such as a fatty alcohol having a C4 to C28 aliphatic hydrocarbon tail. A PCM might also comprise a fatty carbonate ester, sulfonate, or phosphonate, such as a C4 to C28 alkyl carbonate ester, sulfonate, or phosphonate. Moreover, in some embodiments, a PCM comprises a paraffin. A PCM of a PCM layer described herein may also comprises a polymeric material, such as a thermoplastic polymers (e.g., poly(vinyl ethyl ether), poly(vinyl n-butyl ether) and polychloroprene), polyethylene glycols (e.g., CARBOWAX® polyethylene glycol 400, CARBOWAX® polyethylene glycol 600, CARBOWAX® polyethylene glycol 1000, CARBOWAX® polyethylene glycol 1500, CARBOWAX® polyethylene glycol 4600, CARBOWAX® polyethylene glycol 8000, and CARBOWAX® polyethylene glycol 14,000), and polyolefins (e.g., lightly crosslinked polyethylene and/or high density polyethylene).

Again with reference to FIGS. 28-30, a heater or shelf described herein, in some embodiments, further comprises a thermal insulation layer (or a plurality of thermal insulation layers) disposed within the housing. Such a thermal insulation layer (or stack of such layers), in some cases, is disposed immediately adjacent to and in thermal and/or physical contact with a heat sink layer of the heater/shelf. A thermal insulation layer may also be immediately adjacent to and in thermal and physical contact with the skin of the housing (e.g., the top surface or the bottom surface of the housing). Not intending to be bound by theory, it is believed that a thermal insulation layer described herein can slow the distribution of thermal energy provided by the heat generation layer.

Non-limiting examples of a thermal insulation layer is illustrated in FIGS. 28-30. As illustrated in FIGS. 28-30, an optional thermal insulation layer 250, in some preferred embodiments, has a planar or sheet-like structure, and can be placed above the heat generation layer and immediately below the top surface of the housing.

Further, a thermal insulation layer of a heater/shelf described herein, in some implementations, is coextensive or substantially coextensive with the plane of the top or bottom surface of the housing and/or with another adjacent layer (such as a heat sink layer or heat spreading layer) and/or with a heat generation layer, as illustrated, for instance, in FIGS. 28-30. In some embodiments, for example, the planar area of a top or bottom side of a thermal insulation layer is up to 99%, up to 95%, up to 90%, up to 85%, or up to 80% of the planar area of the top or bottom surface, of another adjacent layer, or of the heat generation layer. In some cases, the planar area of a top or bottom side of the thermal insulation layer is 70-100%, 70-99%, 70-95%, 70-90%, 80-100%, 80-99%, 80-95%, 80-90%, 85-100%, 85-99%, 85-95%, 85-90%, 90-100%, 90-99%, or 90-95% of the planar area of the top or bottom surface, of another adjacent layer, or of the heat generation layer. Further, it is to be understood that, in some cases, the thermal insulation layer comprises a hole, aperture, or opening corresponding to the area of the handle assembly of the heater/shelf. For example, in the embodiment illustrated in FIGS. 28-30, the thermal insulation layer 250 comprises a hole 251 corresponding to the handle assembly 210. Such a structure can permit placement of the handle assembly 210 in a position described herein while also providing a desired heating profile or skin surface temperature profile.

A thermal insulation layer can be formed from any material not inconsistent with the objectives of the present disclosure. In some preferred embodiments, the thermal insulation layer is formed from a thermally insulating material such as a foam or fiberglass. In some cases, the thermal insulation layer comprises or is formed from a sheet of Manning glass insulation. Other thermally insulating materials may also be used.

In addition, a thermal insulation layer can have any thickness not inconsistent with the objectives of the present disclosure. In some embodiments, for instance, the thermal insulation layer (or stack of thermal insulation layers) has a thickness (in the z-direction) of no greater than 2 cm or no greater than 1 cm. In some cases, the heat sink layer (or stack of heat sink layers) has a thickness of 0.1-2 cm, 0.1-1.5 cm, 0.1-1 cm, 0.2-2 cm, 0.2-1.5 cm, 0.2-1 cm, 0.2-0.5 cm, 0.5-2 cm, 0.5-1.5 cm, or 0.5-1 cm.

As described above, and as illustrated in FIGS. 28-30, various layers or functional components disposed in the housing of a heater or shelf described herein can be disposed in the housing as a stack. That is, in some embodiments, multiple functional layers (as described above) can be attached, joined, taped, or adhered to one another to form a stack of layers which can together be placed within the housing. In some embodiments, the stack of layers fills the entire interior height of the housing, or substantially the entire interior height of the housing in the z-direction. For example, in some cases, the stack of functional layers has a thickness (in the z-direction) that is at least 95%, at least 97%, or at least 99% of the thickness or height of the interior of the housing, measured from the bottom surface or skin of the housing to the top surface or skin of the housing.

The present disclosure addresses, inter alia, the transportation or delivery of products such as food. It is to be understood that a heater or shelf described herein can be used to heat a product or payload, such as food, including during transportation or delivery of the product or payload, if desired. Thus, in another aspect, methods of heating payloads such as food are described herein. In some such embodiments, a method of heating a payload (such as food) comprises placing the payload in thermal contact with a heater or shelf described herein (e.g., by placing the payload on top of the housing of the heater or shelf, or by placing the payload beneath the housing of the heater or shelf). In some cases, the method further comprises generating thermal energy using the heater or shelf, such as may be achieved by plugging in and/or turning on a heat generation layer of the heater or shelf. Moreover, in some instances, the method further comprises transferring heat or thermal energy provided by the heat generation layer to the payload, such as may occur by conduction of heat from the heat generation layer, through any other layers disposed within the housing, to the skin of the housing, and then to the payload. In some cases, radiative or convective heat transfer may also occur.

### III. Data Collection Devices and Methods of Using the Same

In some embodiments, a food transportation system (e.g., system 1) described herein further comprises a data collection device. Any data collection device not inconsistent with the objectives of the present disclosure may be used. For instance, in some cases, the data collection device comprises an radio frequency identification (RFID) tag, a global positioning system (GPS) tracking device, a temperature monitoring device, a humidity monitoring device, a locking device, or a combination of two or more of the foregoing.

A data collection device (such as an RFID tag or GPS tracking device) can be incorporated within a component of a system, such as being incorporated in one of the layers forming a side wall 10, or lid 4. The RFID tag (or other device) can provide identification information of that individual system 1 unit, for example, such as using a unique identification number or serial number for the specific system 1.

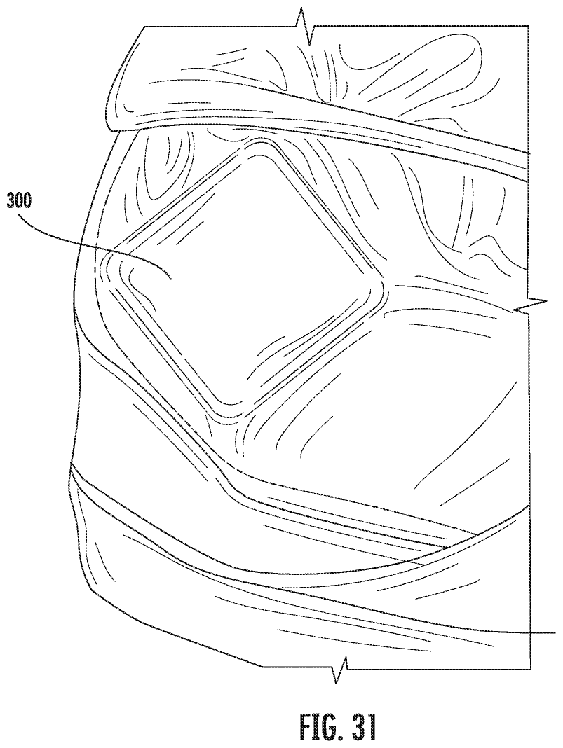

In some instances, the data collection device comprises a GPS tracking device. As illustrated in FIG. 31, a GPS tracking device 300 can be disposed in a pouch attached to the system 1, or otherwise be incorporated or concealed within the system. The GPS tracking device can track a location of the system, which can be used for security purposes, to estimate a delivery arrival time, or track analytics. Analytics can include such information as a number of orders delivered during a given time period, a speed at which a driver was traveling during a delivery, average delivery times, average delivery distance, and the like. In some instances, the GPS tracking device (or other data collection device described herein) can have wireless capabilities, such as being able to wirelessly receive or transmit data using common cellular, Bluetooth, or near-field communication (NFC) frequencies. The GPS tracking device (or other data collection device described herein) can in some cases have a pressure-sensitive on/off switch to activate the device. For example, in some cases, a GPS tracking device disposed in a food delivery system described herein comprises a GPS tracking tile that can be toggled on and off by “pinching” the tile through a pouch, pocket, or compartment containing the device.

A temperature monitoring device and/or a humidity monitoring device can be positioned in an interior compartment of system 1, and can monitor a temperature of the interior compartment or of a payload (such as food) or the humidity of the interior compartment. Analytical data can be recorded or tracked, such as an initial temperature of the payload or internal compartment and a final temperature of the payload or internal compartment at the time of delivery. In some embodiments, the temperature monitoring device and/or the humidity monitoring device can comprise a visual or audible alarm that is activated or triggered when the temperature or humidity of the interior compartment falls below a predetermined threshold. Like the GPS tracking device, in some embodiments, the temperature monitoring device and/or humidity monitoring device can have wireless capabilities to receive and transmit data.

In instances where a locking device is used, the locking device can have wireless communication abilities. For example, the locking device can use Bluetooth or NFC to communicate with an external device such as a cell phone or tablet, and the locking device can be used to securely “lock” and “unlock” access to an interior compartment of the system. For instance, a safety magnetic interlock can be used to close the food containing interior compartment when the food is placed in the interior compartment at the restaurant or point of origin. Then, software or a mobile application (“app”) associated with the Bluetooth device or an RFID tag can be used to monitor and/or record when the compartment is opened (by breaking the magnetic seal, for example). A software or mobile application, with the RFID device, Bluetooth device, or other device can also be used to not only monitor whether the compartment is opened, but also prevent such opening until authorized. For example, a customer who placed the order for delivery can be provided with a code or an RFID mechanism or other mechanism (e.g., through a restaurant- or delivery-service-specific app) that can be used to provide instructions to the bag to unlock the bag once the bag arrives at the customer's specified deliver location. The same result could also be achieved, in other embodiments, through GPS, namely, by keeping the interior compartment locked until the bag arrived at the GPS coordinates of a delivery location.

### IV. Methods of Transporting or Delivering Products

In another aspect, methods of transporting and/or storing a product (such as food) are described herein. In some embodiments, such a method comprises placing the product in the interior volume or compartment of a system described herein. Any system described hereinabove may be used, including a system described hereinabove in Section I optionally having one or more features described hereinabove in Section II and/or Section III. A method described herein can also comprise transporting the product from a first location to a second location and then removing the product from the interior compartment of the system.

In some cases, the product is transported from the first location to the second location and immediately removed for consumption or use at the second location, such as may occur in a food delivery application. In other cases, the product may remain stored in the system for a period of time following arrival at the second location, such as may occur in a food catering or in a cold food or pharmaceutical shipment application. In certain embodiments, for example, for long-range shipment of a cold product such a cold food product or a medical product, the system may maintain the product at a temperature of −50 to 10° C. for up to 5 days.

In some embodiments, whether storage does or does not occur, a method described herein does not comprise attaching the system to an electrical power supply or cooling or heating the interior compartment of the system with a cooling or heating source other than the product itself, after the system leaves or is transported from the first location (i.e., while transporting the product from the first location to the second location). Thus, as described above, in some cases, a method described herein does not comprise actively heating or cooling the product during transport, where “active” heating or cooling can comprise using electrical energy (such as provided by an electrical heating or cooling element or a battery powered heating or cooling element) to heat or cool the payload or interior compartment of the system. It is further to be understood that “active” heating or cooling refers to heating or cooling provided by the system itself, as opposed to being provided incidentally by an external environment or system (e.g., an HVAC system of a vehicle or building in which the product/food transportation system is placed). Instead, a product/food transportation system described herein can “passively” provide the entirety of the payload thermal management functionality in such instances. However, it is also possible to use active heating or cooling, either during transport or after arrival of the product at the second location, including by turning on a heater of the system, as described above.

Additionally, in some embodiments, the system or the interior compartment of a system described herein (such as a system descried hereinabove in Section I) comprises a PCM, and the method further comprises heating or cooling the PCM above or below a phase transition temperature of the PCM prior to placing the product in the interior compartment of the system. Such a “charged” PCM may, in some cases, extend the period of time for which the system can maintain a desired temperature of the product, during transport and/or upon arrival at the second location. In some embodiments, heating or cooling the PCM above or below a phase transition temperature of the PCM causes a phase transition of at least 50% of the total mass of the PCM. In some cases, heating or cooling the PCM above or below a phase transition temperature of the PCM causes a phase transition of at least 60%, at least 70%, at least 80%, at least 90%, or at least 95% of the total mass of the PCM. The PCM can be any PCM described hereinabove or any PCM not inconsistent with the objectives of the present disclosure. Moreover, in some cases, the interior volume or compartment of the system includes a liner or one or more pouches, and a PCM is disposed in the liner or in the one or more pouches.

Further, a PCM disposed in a system described herein can have a phase transition temperature within or near a desired temperature range of the interior compartment of the system during transport of the product (such as food or medicine). For instance, in some cases, the PCM has a phase transition temperature between 50° C. and 135° C., between 50° C. and 100° C., between 50° C. and 95° C., between 65° C. and 80° C., between 70° C. and 95° C., or between 90° C. and 135° C. Such a PCM can help to maintain a product at a temperature of 50-135° C., 50-100° C., 50-95° C., 65-80° C., 70-95° C., or 90-135° C., respectively. In some embodiments, a system described herein (with or without PCM) can maintain a hot food product such as a pizza or chicken (or any of many other food products) at a temperature of 65-80° C. for 60 minutes or more.

Alternatively, in other cases, the PCM has a phase transition temperature between −20° C. and 30° C., between 0° C. and 10° C., between 0° C. and 8° C., between 2° C. and 8° C., or between 15° C. and 35° C. Such a PCM can help to maintain a product at a temperature of within the foregoing ranges, respectively. In some embodiments, a system described herein (with or without PCM) can maintain a cool or cold product, such as a medicine or cold food product, at a temperature of 0-10° C. or 2-8° C. for 60-90 minutes, for 1-20 hours, for 1-120 hours, or more than 120 hours. In certain embodiments, for example, and for a long-range shipment of a cold product such a cold food product or a medical product, the system may maintain the product at a temperature of −50-10° C. for up to 5 days.

In addition, in some instances, the PCM included in a system described herein is “charged” prior to placement of a product within the interior compartment of the system. “Charging” a PCM, for reference purposes herein, comprises heating or cooling a PCM to a temperature above or below, respectively, a transition temperature of the PCM, such that the PCM is “prepared” to provide heating or cooling to the product disposed within the interior compartment without first having to absorb thermal energy from or release thermal energy to the product.

Systems described herein (including in Section I), in some embodiments, can maintain a product disposed in the interior compartment of the system at a desired temperature for a desired period of time. For instance, in some cases, the system maintains the product at a relatively high temperature, such as 50-90° C. or 65-80° C., or 90-135° C., or at a relatively low temperature, such as −20 to −50° C., −20 to 0° C., 0-10° C., 2 to 8° C., 10 to 15° C., or 15 to 25° C. for a time period of at least 20 minutes, at least 30 minutes, at least 40 minutes, at least 60 minutes, at least 90 minutes, at least 120 minutes, at least 4 hours, at least 6 hours, at least 8 hours, at least 20 hours, least 1 day, at least two days, or at least 5 days. In some embodiments, the system maintains the product at a temperature described herein for a time period of 20-120 minutes, 20-90 minutes, 20-60 minutes, 20-40 minutes, 30-120 minutes, 30-90 minutes, 30-60 minutes, 1-8 hours, 1-6 hours, 1-20 hours, 1-120 hours, 1-5 days, 1-3 days, or 1-2 days. Moreover, the desired temperature range and time period can be selected based on a desired application. For instance, for “normal” delivery (i.e., delivery for immediate consumption or use) of a hot food product such as pizza or chicken, the system may maintain the product at a temperature of 65-80° C. for up to 60 minutes, up to 90 minutes, or for 60-90 minutes. For catering delivery, storage, and/or service of a hot food product, the system may maintain the product at a temperature of 90-135° C. for up to 8 hours.

For “normal” delivery of a cold product such as medicine or a cold food product, the system may maintain the product at a temperature of 0-10° C. or 2-8° C. for up to 60 minutes or up to 90 minutes, or for 60-90 minutes. For long-range shipment of a cold product such a cold food product or a medical product, the system may maintain the product at a temperature of −50 to 10° C. for up to 5 days. Additionally, to obtain a desired thermal management property, various properties of the system may be modified as needed. For instance, the amount and/or type of a PCM and/or the use of an active heating or cooling system may be modified.

In some preferred embodiments of a method described herein, the product comprises a food product and the system maintains the food product at a temperature between 65° C. and 75° C. for 60 to 90 minutes or a temperature between 90° C. and 150° C. for 2 to 8 hours. In some such cases, the food product comprises pizza, fries, and/or chicken. In other instances, the product comprises a medical product and the system maintains the medical product at a temperature between 0° C. and 10° C. for 60 to 90 minutes.

In some embodiments, a method described herein further comprises collecting data before, during, or after transport of the product from the first location to the second location. For example, in some cases, a method described herein comprises placing a product in the interior volume or compartment of a system described herein; optionally activating a data collection device described herein (e.g., an RFID tag, a GPS tracking device, a temperature monitoring device or sensor, a humidity monitoring device or sensor, a locking device, or a combination of two or more of the foregoing); transporting the product from a first location to a second location; collecting data described herein (e.g., a location of the system, an estimated delivery arrival time, a number of orders delivered during a given time period, a speed at which a driver was traveling during a delivery, an average delivery time, an average delivery distance, a temperature of the payload or internal compartment, a humidity of the internal compartment, a security status of the internal compartment, such as an “open” or “closed” or “locked” or “unlocked” status, or a combination of two or more of the foregoing) using the data collection device during transport form the first location to the second location; and then removing the product from the interior compartment of the system. Additionally, in some cases, the data collection device is activated prior to departing the first location (which might be a restaurant or other supplier or manufacturer of the product, for example).

Further, in some embodiments, the method comprises sending or transmitting collected data to an external device or system, such as an app, mobile phone, tablet, or cloud computing platform. In some preferred embodiments, the data is transmitted wirelessly (e.g., using one or more cellular, Bluetooth, or near-field communication (NFC) frequencies). Moreover, in some cases, a method described herein further comprises locking a lid or opening of the interior compartment (or all of the lids and openings of the interior compartment) using a locking device, such as safety magnetic interlock. Such locking can occur after the product or payload is placed inside the internal compartment of the system, but before the system is removed from the first location or point of origin (e.g., a restaurant or manufacturer). In addition, in some embodiments, locking is carried out using an external device (such as a cell phone or tablet) of the supplier of the product (e.g., by restaurant personnel). Further, in some embodiments, a method described herein further comprises unlocking the lid or opening of the interior compartment (or all of the lids and openings of the interior compartment) at the second location (e.g., a delivery location), and only at the second location. In some cases, such unlocking is carried out using an external device (such as a cell phone or tablet) of the recipient or consumer of the product (e.g., by a food delivery customer). In other instance, such unlocking occurs automatically based on arrival at the second location, as described above.

Additionally, in some embodiments described herein, a method comprises monitoring data (e.g., temperature, humidity, or any other data described herein) before, during, and/or after transport of the system from the first location to the second location. For example, in some instances, the system comprises a temperature sensor and a humidity sensor and a wireless data transmission device, and the temperature and humidity of the internal compartment are measured on an interval basis or continuously during transport from the first location to the second location. Further, in some such cases, the temperature and humidity data (as a function of time, as a function of location, or otherwise) is transmitted wirelessly to an external device, app, cloud computing platform, or other system for recording and/or analysis. In some embodiments, the temperature and humidity data are monitored, and a visual and/or audible alarm is activated or triggered when the temperature or humidity of the interior compartment falls below a predetermined threshold. In some cases, the visual and/or audible alarm can be provided through an app or other software of the external device receiving transmitted data. In other instances, the visual and/or audible alarm is provided by a visual and/or audible alarm device included in the product transportation system itself (e.g., within fabric layers, within the interior compartment, or elsewhere on or in the system).

Some specific, non-limiting example embodiments of devices and methods described herein are as follows.

Embodiment 1. A food transportation system comprising:
an interior compartment or volume defined by a floor;
one or more side walls; and
a lid,
wherein the lid has a closed configuration and an open configuration; and
wherein the lid, or a bottom surface of the lid, is in facing opposition to the floor, when the lid is in the closed configuration.

Embodiment 2. The system of Embodiment 1, wherein:
the side walls comprise one or more fold lines substantially parallel to the floor of the interior compartment;
the side walls have reduced thickness or rigidity or self-supporting ability at the fold lines;
the interior compartment has an extended configuration and a folded configuration;
when the interior compartment is in the extended configuration, the side walls are substantially orthogonal to the floor; and
when the interior compartment is in the folded configuration, the side walls are folded or collapsed onto themselves along the fold lines and in a direction orthogonal to the floor.

Embodiment 3. The system of Embodiment 1 or Embodiment 2, further comprising at least one opening disposed in the lid or side walls, wherein the opening provides access to the interior compartment from an exterior environment of the system.

Embodiment 4. The system of any of the preceding Embodiments, wherein the side walls are formed from a fabric.

Embodiment 5. The system of any of the preceding Embodiments, wherein the side walls comprise a foam disposed in the interior of the side walls.

Embodiment 6. The system of any of the preceding Embodiments, wherein:
the interior volume is defined by four orthogonal side walls;
two of the four orthogonal side walls, opposite to one another, are formed from a relatively non-rigid material;
the other two of the four orthogonal side walls, also opposite to one another, are formed from a relatively rigid material;
the side walls formed from the relatively rigid material are attached to the side walls from the relatively non-rigid material only at the top of the side walls;
the side walls formed from the relatively rigid material are configured to flip upwardly and downwardly to decrease or increase, respectively, the overall rigidity of the interior volume.

Embodiment 7. The system of any of the preceding Embodiments, wherein the system further comprises a flap or apron disposed within the interior compartment and positioned adjacent to an opening of the interior compartment.

Embodiment 8. The system of Embodiment 7, wherein:
the flap is attached to the side walls or lid of the interior compartment but is not attached to the floor of the interior compartment;
the flap covers the entirety or at least 90% of the entirety of the opening; and/or
the flap is formed from an air-impermeable material.

Embodiment 9. The system of any of the preceding Embodiments, wherein the system further comprises a shelf disposed within the interior volume.

Embodiment 10. The system of Embodiment 9, wherein the shelf divides the interior volume a top portion and bottom portion.

Embodiment 11. The system of Embodiment 9 or Embodiment 10, wherein the shelf comprises a heating element and/or a phase change material.

Embodiment 12. The system of any of Embodiments 9-11, wherein the shelf comprises a top surface and two legs extending substantially orthogonally from the top surface.

Embodiment 13. The system of Embodiment 12, wherein the legs are foldable.

Embodiment 14. The system of Embodiment 13, wherein the legs are attached to the top surface with hinges.

Embodiment 15. The system of any of Embodiments 9-11, wherein:
the shelf is substantially planar or flat;
the system further comprises a plurality of rigid posts disposed within the interior volume and positioned substantially orthogonal to the floor; and
the shelf is configured to rest on and/or be coupled or attached to the rigid posts.

Embodiment 16. The system of Embodiment 15, wherein the posts are disposed in sleeves defined in one or more side walls.

Embodiment 17. The system of Embodiment 15 or Embodiment 16, wherein the posts are formed from metal or plastic.

Embodiment 18. The system of any of Embodiments 9-17, wherein the system further comprises a tether attaching a side wall or the floor of the interior volume to the shelf.

Embodiment 19. The system of any of the preceding Embodiments, wherein the system further comprises a data collection device.

Embodiment 20. The system of Embodiment 19, wherein the data collection device comprise a GPS tracking device, a temperature monitoring device, a humidity monitoring device, or a combination of two or more of the foregoing.

Embodiment 21. The system of Embodiment 19 or Embodiment 20, wherein:
the tracking device is disposed in pouch attached to the system; and
the tracking device comprises a pressure-sensitive on/off switch.

Embodiment 22. A method of transporting food, the method comprising:
placing the food in the interior volume of the system of any of Embodiments 1-21;
transporting the food from a first location to a second location; and
removing the food from the interior volume of the system.

Embodiment 23. The method of Embodiment 21, wherein the method does not comprise attaching the system to an electrical power supply while transporting the food from the first location to the second location.

Embodiment 24. The method of Embodiment 22 or Embodiment 23, wherein:
the system comprises a phase change material disposed in the interior volume of the system; and
the method further comprises heating or cooling the phase change material above or below a phase transition temperature of the phase change material prior to placing the food in the interior volume of the system.

Embodiment 25. The method of Embodiment 24, wherein heating or cooling the phase change material above or below a phase transition temperature of the phase change material causes a phase transition of at least 50% of the total mass of the phase change material.

Embodiment 26. The method of any of Embodiments 22-25, wherein:
the system comprises a data collection device (e.g., an RFID tag, a GPS tracking device, a temperature monitoring device or sensor, a humidity monitoring device or sensor, a locking device, or a combination of two or more of the foregoing);
the method further comprises activating the data collection device; and
the method further comprises collecting data (e.g., a location of the system, an estimated delivery arrival time, a number of orders delivered during a given time period, a speed at which a driver was traveling during a delivery, an average delivery time, an average delivery distance, a temperature of the payload or internal compartment, a humidity of the internal compartment, a security status of the internal compartment, or a combination of two or more of the foregoing) using the data collection device before, during, or after transport from the first location to the second location.

Embodiment 27. The method of Embodiment 26, wherein:
the data collection device is activated prior to departing the first location.

Embodiment 28. The method of Embodiment 26 or Embodiment 27, wherein:
the method further comprises transmitting collected data to an external device or system (e.g., an app, mobile phone, tablet, or cloud computing platform).

Embodiment 29. The method of Embodiment 28, wherein the data is transmitted wirelessly (e.g., using one or more cellular, Bluetooth, or near-field communication (NFC) frequencies).

Embodiment 30. The method of any of Embodiments 22-28, wherein:
the method further comprises locking a lid or opening of the interior compartment (or all of the lids and openings of the interior compartment) using a locking device; and
the locking occurs after the product is placed inside the internal compartment of the system, but before the system is removed from the first location.

Embodiment 31. The method of Embodiment 30, wherein:
the method further comprises unlocking the lid or opening of the interior compartment (or all of the lids and openings of the interior compartment) at the second location.

Embodiment 32. The method of Embodiment 31, wherein:
locking is carried out by a provider or manufacturer of the product at the first location; and
unlocking is carried out by a recipient or consumer of the product at the second location, or unlocking is carried out automatically by the locking device based on arrival at the second location.

Embodiment 33. The method of any of Embodiments 26-32, wherein:
the method comprises monitoring condition data (e.g., temperature or humidity) before, during, and/or after transport of the system from the first location to the second location; and
a visual and/or audible alarm is activated when the condition data (e.g., temperature or humidity) falls outside a predetermined condition window or performance threshold.

Various implementations of apparatus and methods have been described in fulfillment of the various objectives of the present disclosure. It should be recognized that these implementations are merely illustrative of the principles of the present disclosure. Numerous modifications and adaptations thereof will be readily apparent to those skilled in the art without departing from the spirit and scope of the present disclosure. For example, individual steps of methods described herein can be carried out in any manner and/or in any order not inconsistent with the objectives of the present disclosure, and various configurations or adaptations of apparatus described herein may be used.

1. A food transportation system comprising:
an interior compartment defined by a floor, one or more side walls, and a lid, wherein the side walls comprise one or more fold lines substantially parallel to the floor of the interior compartment;
wherein the side walls have reduced thickness at the fold lines;
wherein the interior compartment has an extended configuration and a folded configuration;
wherein, when the interior compartment is in the extended configuration, the side walls are substantially orthogonal to the floor; and
wherein, when the interior compartment is in the folded configuration, the side walls are folded along the fold lines and in a direction orthogonal to the floor.

2. The system of claim 1, wherein the side walls are formed from a fabric.

3. The system of claim 1, wherein the side walls comprise a foam disposed in the interior of the side walls.

4. The system of claim 1, wherein:
when the interior compartment is in the extended configuration, the interior compartment is defined by four orthogonal side walls;
two of the four orthogonal side walls, opposite to one another, are formed from a relatively non-rigid material;
the other two of the four orthogonal side walls, also opposite to one another, are formed from a relatively rigid material;
the side walls formed from the relatively rigid material are attached to the side walls formed from the relatively non-rigid material only at the top of the side walls; and
the side walls formed from the relatively rigid material are configured to flip upwardly and downwardly to decrease or increase, respectively, the overall rigidity of the interior compartment.

5. The system of claim 1, wherein the system further comprises:
an opening that provides access to the interior compartment from an exterior environment of the system; and
a flap disposed within the interior compartment and positioned adjacent to the opening.

6. The system of claim 5, wherein:
the flap is attached to the side walls or lid of the interior compartment but is not attached to the floor of the interior compartment;
the flap covers at least 90% of the entirety of the opening; and/or
the flap is formed from an air-impermeable material.

7. The system of claim 1, wherein the system further comprises a shelf disposed within the interior compartment.

8. The system of claim 7, wherein the shelf divides the interior compartment into a top portion and bottom portion.

9. The system of claim 7, wherein the shelf comprises a heating element and/or a phase change material.

10. The system of claim 7, wherein the shelf comprises a top surface and two legs extending substantially orthogonally from the top surface.

11. The system of claim 10, wherein the legs are foldable.

12. The system of claim 11, wherein the legs are attached to the top surface with hinges.

13. The system of claim 7, wherein:
the shelf is substantially planar;
the system further comprises a plurality of rigid posts disposed within the interior compartment and positioned substantially orthogonal to the floor;
the shelf is configured to rest on and/or be coupled or attached to the rigid posts.

14. The system of claim 13, wherein the posts are disposed in sleeves defined in one or more side walls.

15. The system of claim 13, wherein the posts are formed from metal.

16. The system of claim 7, wherein the system further comprises a tether attaching a side wall or the floor of the interior compartment to the shelf.

17. The system of claim 1, wherein the system further comprises a data collection device.

18. The system of claim 17, wherein the data collection device comprises an RFID device, a GPS tracking device, a temperature monitoring device, a humidity monitoring device, or a combination of two or more of the foregoing.

19. The system of claim 18, wherein:
the tracking device is disposed in pouch attached to the system; and
the tracking device comprises a pressure-sensitive on/off switch.

20. A method of transporting food, the method comprising:
placing the food in the interior compartment of the system of claim 1;
transporting the food from a first location to a second location; and
removing the food from the interior compartment of the system.

21. (canceled)

22. (canceled)

23. (canceled)
